(19) United States
(12) Patent Application Publication
(10) Pub. No.: US 2025/0301483 A1
(43) Pub. Date: Sep. 25, 2025

(54) DEVICE AND METHOD FOR PERFORMING MULTI-CARRIER SCHEDULING IN WIRELESS COMMUNICATION SYSTEM

(71) Applicant: LG ELECTRONICS INC., Seoul (KR)

(72) Inventors: Seungjin AHN, Seoul (KR); Suckchel YANG, Seoul (KR); Seonwook KIM, Seoul (KR); Seunghwan CHOI, Seoul (KR)

(73) Assignee: LG ELECTRONICS INC., Seoul (KR)

(21) Appl. No.: 18/860,300

(22) PCT Filed: Apr. 19, 2023
(86) PCT No.: PCT/KR2023/005273

§ 371 Date: Oct. 25, 2024

Related U.S. Application Data
(60) Provisional application No. 63/335,232, filed on Apr. 27, 2022.
(60) Provisional application No. 63/446,030, filed on Feb. 16, 2023.

(30) Foreign Application Priority Data
Aug. 11, 2022 (KR) 10-2022-0100689

(51) Int. Cl. H04W 72/232; H04L 1/00; H04W 74/0833

(52) U.S. Cl. CPC H04W 72/232; H04L 1/0003; H04W 74/0833

(57) ABSTRACT

A method for operating a user equipment (UE) in order to perform multi-carrier scheduling in a wireless communication system disclosed herein may comprise the steps of: performing an access procedure with a base station; performing, with the base station, a connection establishment procedure for a primary cell; performing, with the base station, a connection establishment procedure for at least one secondary cell; receiving downlink control information (DCI) from the base station; and receiving data by using resources indicated in the DCI.

### CROSS-REFERENCE TO RELATED APPLICATIONS

This application is the National Stage filing under 35 U.S.C. 371 of International Application No. PCT/KR2023/005273, filed on Apr. 19, 2023, which claims the benefit of earlier filing date and right of priority to Korean Application No. 10-2022-0100689, filed on Aug. 11, 2022, and also claims the benefit of U.S. Provisional Application No. 63/335,232, filed on Apr. 27, 2022, and 63/446,030, filed on Feb. 16, 2023, the contents of which are all hereby incorporated by reference herein in their entireties.

### TECHNICAL FIELD

The present disclosure relates to a wireless communication system, and more particularly, to an apparatus and method for performing multi-carrier scheduling in a wireless communication system.

### BACKGROUND

Wireless communication systems have been widely deployed to provide various types of communication services such as voice or data. In general, a wireless communication system is a multiple access system that supports communication of multiple users by sharing available system resources (a bandwidth, transmission power, etc.). Examples of multiple access systems include a code division multiple access (CDMA) system, a frequency division multiple access (FDMA) system, a time division multiple access (TDMA) system, an orthogonal frequency division multiple access (OFDMA) system, and a single carrier frequency division multiple access (SC-FDMA) system.

In particular, as a large number of communication devices require a large communication capacity, the enhanced mobile broadband (eMBB) communication technology, as compared to the conventional radio access technology (RAT), is being proposed. In addition, not only massive machine type communications (massive MTC), which provide a variety of services anytime and anywhere by connecting multiple devices and objects, but also a communication system considering a service/user equipment (UE) sensitive to reliability and latency is being proposed. Various technical configurations for this are being proposed.

### SUMMARY

The present disclosure may provide an apparatus and method for allocating a resource more effectively in a wireless communication system.

The present disclosure may provide an apparatus and method for performing multi-carrier scheduling in a wireless communication system.

The present disclosure may provide an apparatus and method for allocating a resource for a plurality of cells by using a physical downlink control channel (PDCCH) in a wireless communication system.

The present disclosure may provide an apparatus and method for performing scheduling for a physical downlink shared channel (PDSCH) or a physical uplink shared channel (PUSCH) of a plurality of cells by using a PDCCH of one cell in a wireless communication system.

The present disclosure may provide an apparatus and method for transmitting and receiving downlink control information (DCI) including scheduling information for a plurality of cells through a PDCCH of one cell in a wireless communication system.

The present disclosure may provide an apparatus and method for configuring a modulation and coding scheme (MCS) field for a plurality of cells in a wireless communication system.

The present disclosure may provide an apparatus and method for including MCS values for a plurality of cells in an MCS field in a wireless communication system.

The present disclosure may provide an apparatus and method for indicating MCS information by using some of MCS indexes defined in an MCS table in a wireless communication system.

The present disclosure may provide an apparatus and method for defining an MCS table based on the number of cells that are scheduled together in a wireless communication system.

The present disclosure may provide an apparatus and method for dividing an MCS field for a plurality of cells in a wireless communication system.

The present disclosure may provide an apparatus and method for indicating MCS information for a plurality of cells by using a common MCS value in a wireless communication system.

The present disclosure may provide an apparatus and method for indicating MCS information for a plurality of cells by using a reference MCS value and delta values in a wireless communication system.

The present disclosure may provide an apparatus and method for indicating MCS information of a plurality transport blocks (TBs) by using a common MCS value in a wireless communication system.

Technical objects to be achieved in the present disclosure are not limited to what is mentioned above, and other technical objects not mentioned therein can be considered from the embodiments of the present disclosure to be described below by those skilled in the art to which a technical configuration of the present disclosure is applied.

As an example of the present disclosure, an operating method of a user equipment (UE) in a wireless communication system may include performing an access procedure with a base station, performing a connection establishment procedure for a primary cell with the base station, performing a connection establishment procedure for at least one secondary cell with the base station, receiving downlink control information (DCI) from the base station, and receiving data by using resources indicated by the DCI. The DCI may include information indicating modulation and coding scheme (MCS) information applied to a plurality of cells including the primary cell and the at least one secondary cell.

As an example of the present disclosure, an operating method of a base station in a wireless communication system may include performing an access procedure with a user equipment (UE), performing a connection establishment procedure for a primary cell of the UE, performing a connection establishment procedure for at least one secondary cell of the UE, transmitting downlink control information (DCI) to the UE, and transmitting data by using resources indicated by the DCI.

The DCI may include information indicating modulation and coding scheme (MCS) information applied to a plurality of cells including the primary cell and the at least one secondary cell.

As an example of the present disclosure, a user equipment (UE) in a wireless communication system may include a transceiver and a processor coupled with the transceiver, the processor may be configured to perform an access procedure with a base station, to perform a connection establishment procedure for a primary cell with the base station, to perform a connection establishment procedure for at least one secondary cell with the base station, to receive downlink control information (DCI) from the base station, and to receive data by using resources indicated by the DCI, and the DCI may include information indicating modulation and coding scheme (MCS) information applied to a plurality of cells including the primary cell and the at least one secondary cell.

As an example of the present disclosure, a base station in a wireless communication system may include a transceiver and a processor coupled with the transceiver, the processor may be configured to perform an access procedure with a user equipment (UE), to perform a connection establishment procedure for a primary cell of the UE, to perform a connection establishment procedure for at least one secondary cell of the UE, to transmit downlink control information (DCI) to the UE, and to transmit data by using resources indicated by the DCI, and the DCI may include information indicating modulation and coding scheme (MCS) information applied to a plurality of cells including the primary cell and the at least one secondary cell.

As an example of the present disclosure, a communication device may include at least one processor and at least one computer memory coupled with the at least one processor and storing an instruction that instructs operations when executed by the at least one processor, and the operations may include performing an access procedure with a base station, performing a connection establishment procedure for a primary cell with the base station, performing a connection establishment procedure for at least one secondary cell with the base station, receiving downlink control information (DCI) from the base station, and receiving data by using resources indicated by the DCI. The DCI may include information indicating modulation and coding scheme (MCS) information applied to a plurality of cells including the primary cell and the at least one secondary cell.

As an example of the present disclosure, a non-transitory computer-readable medium storing at least one instruction may include the at least one instruction that is executable by a processor, and the at least one instruction may instruct a device to perform an access procedure with a base station, to perform a connection establishment procedure for a primary cell with the base station, to perform a connection establishment procedure for at least one secondary cell with the base station, to receive downlink control information (DCI) from the base station, and to receive data by using resources indicated by the DCI, and the DCI may include information indicating modulation and coding scheme (MCS) information applied to a plurality of cells including the primary cell and the at least one secondary cell.

The above-described aspects of the present disclosure are merely a part of exemplary embodiments of the present disclosure, and various embodiments reflecting technical features of the present disclosure may be derived and understood by those skilled in the art based on the detailed description of the present disclosure below.

As is apparent from the above description, the embodiments of the present disclosure have the following effects.

According to the present disclosure, scheduling for a plurality of cells may be efficiently performed.

It will be appreciated by persons skilled in the art that that the effects that can be achieved through the embodiments of the present disclosure are not limited to those described above and other advantageous effects of the present disclosure will be more clearly understood from the following detailed description. That is, unintended effects according to implementation of the present disclosure may be derived by those skilled in the art from the embodiments of the present disclosure.

### BRIEF DESCRIPTION OF THE DRAWINGS

The accompanying drawings are provided to aid understanding of the present disclosure, and embodiments of the present disclosure may be provided together with a detailed description. However, the technical features of the present disclosure are not limited to a specific drawing, and features disclosed in each drawing may be combined with each other to constitute a new embodiment. Reference numerals in each drawing may mean structural elements.

FIG. 1 illustrates an example of a structure of a wireless communication system to which the present disclosure may be applied.

FIG. 2 illustrates an example of a wireless device applicable to the present disclosure.

FIG. 3 illustrates a frame structure in a wireless communication system to which the present disclosure may be applied.

FIG. 4 illustrates an example of a resource grid in a wireless communication system to which the present disclosure may be applied.

FIG. 5 illustrates an example of a physical resource block in a wireless communication system to which the present disclosure may be applied.

FIG. 6 illustrates an example of a slot structure in a wireless communication system to which the present disclosure may be applied.

FIG. 7 illustrates examples of physical channels used in a wireless communication system, to which the present disclosure may be applied, and an example of a general signal transmission and reception method using the physical channels.

FIG. 8 illustrates examples of MCS tables according to channel quality in a wireless communication system according to an embodiment of the present disclosure.

FIG. 9 illustrates an example of MCS grouping for multi-carrier scheduling in a wireless communication system according to an embodiment of the present disclosure.

FIG. 10 illustrates an example of an MCS index group in multi-carrier scheduling in a wireless communication system according to an embodiment of the present disclosure.

FIG. 11 illustrates an example of a cell group using a same MCS index in a wireless communication system according to an embodiment of the present disclosure.

FIG. 12 illustrates an example of MCS-based delta operation of a reference CC in a wireless communication system according to an embodiment of the present disclosure.

FIG. 13 illustrates an example of reference MCS-based delta operation in a wireless communication system according to an embodiment of the present disclosure.

FIG. 14 illustrates an example structure of an MCS field of MC-DCI in a wireless communication system according to an embodiment of the present disclosure.

FIG. 15 illustrates an example structure of an MCS field of MC-DCI in a wireless communication system according to an embodiment of the present disclosure.

FIG. 16 illustrates an example of a procedure for performing communication by a base station according to multi-carrier scheduling in a wireless communication system according to an embodiment of the present disclosure.

FIG. 17 illustrates an example of a procedure for performing communication by a terminal according to multi-carrier scheduling in a wireless communication system according to an embodiment of the present disclosure.

FIG. 18 illustrates an example of a procedure for indicating a resource allocation situation by using a radio network temporary identifier (RNTI) in a wireless communication system according to an embodiment of the present disclosure.

FIG. 19 illustrates an example of a procedure for performing multi-carrier scheduling according to a separate-equal scheme in a wireless communication system according to an embodiment of the present disclosure.

FIG. 20 illustrates an example of a procedure for performing multi-carrier scheduling according to a shared-common scheme in a wireless communication system according to an embodiment of the present disclosure.

FIG. 21 illustrates an example of a procedure for performing multi-carrier scheduling according to a shared-common scheme between cells and a separate-delta scheme between TBs in a wireless communication system according to an embodiment of the present disclosure.

FIG. 22 illustrates an example of a procedure for performing multi-carrier scheduling according to a separate-delta scheme in a wireless communication system according to an embodiment of the present disclosure.

FIG. 23 illustrates an example of a procedure for performing multi-carrier scheduling according to a separate-equal scheme between cells and a separate-delta scheme between TBs in a wireless communication system according to an embodiment of the present disclosure.

### DETAILED DESCRIPTION

The embodiments of the present disclosure described below are combinations of elements and features of the present disclosure in specific forms. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions or elements of any one embodiment may be included in another embodiment and may be replaced with corresponding constructions or features of another embodiment.

In the description of the drawings, procedures or steps which render the scope of the present disclosure unnecessarily ambiguous will be omitted and procedures or steps which can be understood by those skilled in the art will be omitted.

Throughout the specification, when a certain portion “includes” or “comprises” a certain component, this indicates that other components are not excluded and may be further included unless otherwise noted. The terms “unit”, “-or/er” and “module” described in the specification indicate a unit for processing at least one function or operation, which may be implemented by hardware, software or a combination thereof. In addition, the terms “a or an”, “one”, “the” etc. may include a singular representation and a plural representation in the context of the present disclosure (more particularly, in the context of the following claims) unless indicated otherwise in the specification or unless context clearly indicates otherwise.

In the embodiments of the present disclosure, a description is mainly made of a data transmission and reception relationship between a base station (BS) and a mobile station. A BS refers to a terminal node of a network, which directly communicates with a mobile station. A specific operation described as being performed by the BS may be performed by an upper node of the BS.

Namely, it is apparent that, in a network comprised of a plurality of network nodes including a BS, various operations performed for communication with a mobile station may be performed by the BS, or network nodes other than the BS. The term “BS” may be replaced with a fixed station, a Node B, an evolved Node B (eNode B or eNB), an advanced base station (ABS), an access point, etc.

In the embodiments of the present disclosure, the term terminal may be replaced with a UE, a mobile station (MS), a subscriber station (SS), a mobile subscriber station (MSS), a mobile terminal, an advanced mobile station (AMS), etc.

A transmitter is a fixed and/or mobile node that provides a data service or a voice service and a receiver is a fixed and/or mobile node that receives a data service or a voice service. Therefore, a mobile station may serve as a transmitter and a BS may serve as a receiver, on an uplink (UL). Likewise, the mobile station may serve as a receiver and the BS may serve as a transmitter, on a downlink (DL).

The embodiments of the present disclosure may be supported by standard specifications disclosed for at least one of wireless access systems including an Institute of Electrical and Electronics Engineers (IEEE) 802.xx system, a 3rd Generation Partnership Project (3GPP) system, a 3GPP Long Term Evolution (LTE) system, 3GPP 5th generation (5G) new radio (NR) system, and a 3GPP2 system. In particular, the embodiments of the present disclosure may be supported by the standard specifications, 3GPP TS 36.211, 3GPP TS 36.212, 3GPP TS 36.213, 3GPP TS 36.321 and 3GPP TS 36.331.

In addition, the embodiments of the present disclosure are applicable to other radio access systems and are not limited to the above-described system. For example, the embodiments of the present disclosure are applicable to systems applied after a 3GPP 5G NR system and are not limited to a specific system.

That is, steps or parts that are not described to clarify the technical features of the present disclosure may be supported by those documents. Further, all terms as set forth herein may be explained by the standard documents.

Reference will now be made in detail to the embodiments of the present disclosure with reference to the accompanying drawings. The detailed description, which will be given below with reference to the accompanying drawings, is intended to explain exemplary embodiments of the present disclosure, rather than to show the only embodiments that can be implemented according to the disclosure.

The following detailed description includes specific terms in order to provide a thorough understanding of the present disclosure. However, it will be apparent to those skilled in the art that the specific terms may be replaced with other terms without departing the technical spirit and scope of the present disclosure.

The embodiments of the present disclosure can be applied to various radio access systems such as code division multiple access (CDMA), frequency division multiple access (FDMA), time division multiple access (TDMA), orthogonal frequency division multiple access (OFDMA), single carrier frequency division multiple access (SC-FDMA), etc.

Hereinafter, in order to clarify the following description, a description is made based on a 3GPP communication system (e.g., LTE, NR, etc.), but the technical spirit of the present disclosure is not limited thereto. LTE may refer to technology after 3GPP TS 36.xxx Release 8. In detail, LTE technology after 3GPP TS 36.xxx Release 10 may be referred to as LTE-A, and LTE technology after 3GPP TS 36.xxx Release 13 may be referred to as LTE-A pro. 3GPP NR may refer to technology after TS 38.xxx Release 15. 3GPP 6G may refer to technology TS Release 17 and/or Release 18. “xxx” may refer to a detailed number of a standard document. LTE/NR/6G may be collectively referred to as a 3GPP system.

3GPP 6G may mean a post-3GPP NR technology based on a 3GPP system. 3GPP 6G may not limited to a Release or a specific TS document, and its name may have a different form from 3GPP 6G. That is, 3GPP 6G may mean a technology introduced after 3GPP NR and is not limited to a specific form.

The description below will mainly focus on a 3GPP NR system but is not limited thereto and may be applied to 3GPP 6G. Furthermore, what is described below may be partially modified to be used in consideration of a 3GPP 6G system and is not limited to a specific form. However, hereinafter, for convenience of explanation, the 3GPP NR system will be mainly described. For background arts, terms, abbreviations, etc. used in the present disclosure, refer to matters described in the standard documents published prior to the present disclosure. For example, reference may be made to the standard documents 36.xxx and 38.xxx.

### Overall System

As more communication devices require larger communication capacities, the need for mobile broadband communication more enhanced than the existing Radio Access Technology (RAT) is on the rise. In addition, massive machine type communication (MTC), which provides a variety of services anytime and anywhere by connecting a plurality of devices and things, is also one of main issues worthy of consideration in next-generation communication. Furthermore, a communication system design considering a service/a terminal sensitive to reliability and latency is also under discussion. Thus, introduction of a next-generation RAT considering enhanced mobile broadband communication (eMBB), massive MTC (mMTC), ultra-reliable and low latency communication (URLLC) and the like is under discussion, and for convenience, a corresponding technology is referred to as NR in the present disclosure. NR is an expression which represents an example of a 5G RAT.

A new RAT system including NR uses an OFDM transmission method or a similar transmission method. The new RAT system may follow OFDM parameters different from OFDM parameters of LTE. Alternatively, the new RAT system may follow a numerology of the existing LTE/LTE-A as it is but support a wider system bandwidth (e.g., 100 MHz). Alternatively, one cell may support a plurality of numerologies. In other words, terminals which operate in accordance with different numerologies may coexist in one cell.

A numerology corresponds to one subcarrier spacing in a frequency domain. As a reference subcarrier spacing is scaled by an integer N, a different numerology may be defined.

In addition, a new RAT system including 6G may be considered as a next-generation RAT. The new RAT system including 6G may consider i) very high data speed per device, ii) a large number of connected devices, iii) global connectivity, iv) very low latency, v) reduction of energy consumption of battery-free IoT devices, vi) ultra-high reliability connection, and vii) a connected intelligence with machine learning ability, but is not limited thereto. The new RAT system including 6G may consider using a terahertz (THz) frequency band, that is, a frequency higher than an NR system, for a wider bandwidth and a higher transmission speed in consideration of what is described above. The RAT system including 6G may overcome an existing limitation by applying artificial intelligence/machine learning (AI/ML), but may not be limited thereto.

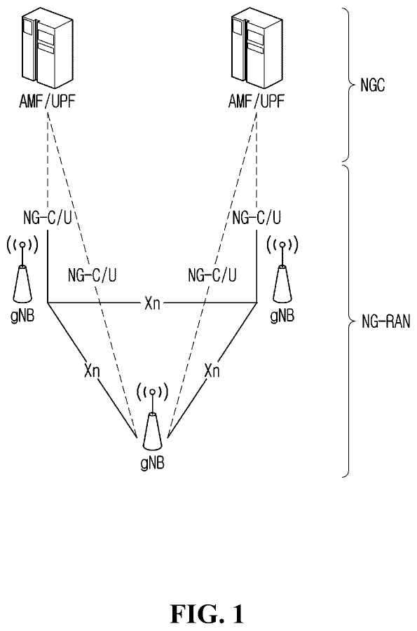

FIG. 1 exemplifies a structure of a wireless communication system to which the present disclosure may be applied. Referring to FIG. 1, NG-RAN consists of gNBs that provide control plane (RRC) protocol terminations for a NG-Radio Access (NG-RA) user plane (that is, a new access stratum (AS) sublayer/packet data convergence protocol (PDCP)/radio link control (RLC)/MAC/PHY) and a UE. The gNBs are interconnected through a Xn interface. In addition, the gNBs are connected to a new generation core (NGC) through an N2 interface. More specifically, the gNBs are connected to a access and mobility management function (AMF) through an N2 interface and are connected to a user plane function (UPF) through an N3 interface. FIG. 1 may be a structure based on an NR system, the structure of FIG. 1 may be used in a 6G system either as it is or by being partially modified and is not limited to a specific form.

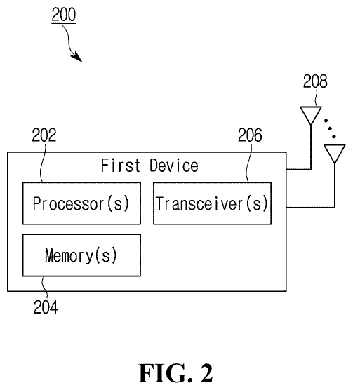

FIG. 2 illustrates an example of a wireless device applicable to the present disclosure.

Referring to FIG. 2, a wireless device 200 may transmit/receive a radio signal through various wireless access technologies (e.g., LTE, LTE-A, LTE-A pro, NR, 5G, 5G-A, 6G). The wireless device 200 may include at least one processor 202 and at least one memory 204 and additionally further include at least one transceiver 206 and/or at least one antenna 208.

The processor 202 may be configured to control the memory 204 and/or the transceiver 206 and to implement the descriptions, functions, procedures, proposals, methods, and/or operation flowcharts disclosed in this document. For example, the processor 202 may generate first information/signal by processing information in the memory 204 and then transmit a radio signal including the first information/signal through the transceiver 206. In addition, the processor 202 may receive a radio signal including second information/signal through the transceiver 206 and then store information obtained from signal processing of the second information/signal in the memory 204. The memory 204 may be connected to the processor 202 and store a variety of information associated with an operation of the processor 202. For example, the memory 204 may store a software code including instructions for implementing some or all of processes controlled by the processor 202 or for implementing the descriptions, functions, procedures, proposals, methods, and/or operation flowcharts disclosed in this document. Herein, the processor 202 and the memory 204 may be a part of a communication modem/circuit/chip designed for implementing a wireless communication technology. The transceiver 206 may be connected to the processor 202 and transmit and/or receive a radio signal through the at least one antenna 208. The transceiver 206 may be a transmitter and/or a receiver. The transceiver 206 may be used interchangeably with a radio frequency (RF) unit. In the present disclosure, a wireless device may mean a communication modem/circuit/chip.

Hereinafter, a hardware element of the wireless device 200 will be described in further detail. Although not being limited thereto, at least one protocol layer may be implemented by the at least one processor 202. For example, the at least one processor 202 may implement at least one layer (e.g., a functional layer such as physical (PHY), media access control (MAC), radio link control (RLC), packet data convergence protocol (PDCP), radio resource control (RRC), and service data adaptation protocol (SDAP)). The at least one processor 202 may generate at least one protocol data unit (PDU) and/or at least one service data unit (SDU) according to the descriptions, functions, procedures, proposals, methods, and/or operation flowcharts disclosed in this document. The at least one processor 202 may generate a message, control information, data, or information according to the descriptions, functions, procedures, proposals, methods, and/or operation flowcharts disclosed in this document. The at least one processor 202 may generate a signal (e.g., a baseband signal) including a PDU, an SDU, a message, control information, data, or information according to a function, a procedure, a suggestion and/or a method, which are disclosed in the present document, and provide the signal to the at least one transceiver 206. The at least one processor 202 may receive a signal (e.g., a baseband signal) from the at least one transceiver 206 and obtain a PDU, an SDU, a message, control information, data, or information according to the descriptions, functions, procedures, proposals, methods, and/or operation flowcharts disclosed in this document.

The at least one processor 202 may be referred to as a controller, a microcontroller, a microprocessor, or a microcomputer. The at least one processor 202 may be implemented by hardware, firmware, software, or a combination thereof. As an example, at least one application specific integrated circuit (ASIC), at least one digital signal processor (DSP), at least one digital signal processing devices (DSPD), at least one programmable logic device (PLD), or at least one field programmable gate array (FPGA) may be included in the at least one processor 202. The descriptions, functions, procedures, proposals, methods, and/or operation flowcharts disclosed in this document may be implemented using firmware or software, and the firmware or software may be implemented to include the modules, procedures, or functions. Firmware or software configured to perform the descriptions, functions, procedures, proposals, methods, and/or operation flowcharts disclosed in this document may be included in the at least one processor 202 or may be stored in the at least one memory 204 and executed by the at least one processor 202. The descriptions, functions, procedures, proposals, methods, and/or operation flowcharts disclosed in this document may be implemented using firmware or software in the form of code, an instruction, and/or a set of instructions.

The at least one memory 204 may be connected to the at least one processor 202 and store various forms of data, signals, messages, information, programs, codes, indications, and/or instructions. The at least one memory 204 may be configured as a read only memory (ROM), a random access memory (RAM), an erasable programmable read only memory (EPROM), a flash memory, a hard drive, a register, a cache memory, a computer-readable storage media, and/or a combination thereof. The at least one memory 204 may be located at the interior and/or exterior of the at least one processor 202. In addition, the at least one memory 204 may be connected to the at least one processor 202 through various technologies such as wired or wireless connection.

The at least one transceiver 206 may transmit user data, control information, and wireless signals/channels, mentioned in the methods and/or operation flowcharts of this document, to at least one other device. The at least one transceiver 206 may receive user data, control information, and wireless signals/channels, mentioned in the descriptions, functions, procedures, proposals, methods, and/or operation flowcharts disclosed in this document, from at least one other device. For example, the at least one transceiver 206 may be connected to the at least one processor 202 and transmit and receive radio signals. For example, the at least one processor 202 may control the at least one transceiver 206 to transmit user data, control information, or a radio signal to at least one other device. In addition, the at least one processor 202 may control the at least one transceiver 206 to receive user data, control information, or a radio signal from at least one other device. In addition, the at least one transceiver 206 may be connected to the at least one antenna 208, and the at least one transceiver 206 may be configured to transmit and receive user data, control information, radio signals/channels mentioned in the descriptions, functions, procedures, proposals, methods and/or operation flowcharts disclosed in this document through the at least one antenna 208. In this document, the at least one antenna may be a plurality of physical antennas or a plurality of logical antennas (e.g., antenna ports). The at least one transceiver 206 may convert received radio signals/channels from RF band signals into baseband signals in order to process received user data, control information, and radio signals/channels using the at least one processor 202. The at least one transceiver 206 may convert the user data, control information, and radio signals/channels processed using the at least one processor 202 from the baseband signals into the RF band signals. To this end, the at least one transceiver 206 may include an (analog) oscillator and/or a filter.

The constituents of the wireless device, which are described in reference to FIG. 2, may be referred to as other terms from functional aspects. For example, the processor 202 may be referred to as a control unit, the transceiver 206 may be referred to as a communication unit, and the memory 204 may be referred to as a storage unit. In some cases, the communication unit may be used for a meaning including at least a part of the processor 202 and the transceiver 206.

The structure of the wireless device, which is described in reference to FIG. 2, may be understood as a structure of at least a part of various devices. As an example, the structure may be at least a part of various devices (e.g., a robot, a vehicle, an XR device, a hand-held device, a home appliance, an IoT device, an AI device/a server, etc.). Furthermore, according to various embodiments, apart from the constituents exemplified in FIG. 2, a device may further other constituents.

For example, a device may be a hand-held device such as a smartphone, a smart pad, a wearable device (e.g., a smart watch, smart glasses), and a hand-held computer (e.g., a laptop, etc.). In this case, the device may further include at least one of a power supply unit that supplies power and includes a wired/wireless charging circuit, a battery and the like, an interface unit including at least one port (e.g., an audio input/output port, a video input/output port) for connection to another device, and an input/output unit for inputting and outputting video information/signals, audio information/signals, data and/or information input from a user.

For example, a device may be a mobile device such as a mobile robot, a vehicle, a train, a manned/unmanned aerial vehicle (AV), and a ship. In this case, the device may further include at least one of a drive unit including at least one of the engine, motor, powertrain, wheels, brake, and steering device of the device, a power supply unit that supplies power and includes a wired/wireless charging circuit, a battery and the like, a sensor unit that senses state information of the device or surrounding the device, environment information and user information, an autonomous driving unit that performs functions such as route maintenance, speed control and destination setting, and a location measurement unit that obtains moving object location information through a global positioning system (GPS) and various sensors.

For example, a device may be an XR device such as an HMD, a head-up display (HUD) provided in a vehicle, a television, a smartphone, a wearable device, a home appliance device, a digital signage, a vehicle, and a robot. In this case, the device may further include at least one of a power supply unit that supplies power and includes a wired/wireless charging circuit, a battery and the like, an input/output unit that obtains control information and data from outside and outputs a generated XR object, and a sensor unit that senses state information of the device or surrounding the device, environment information and user information.

For example, a device may be a robot that may be classified for industrial use, medical use, domestic use, military use and the like according to purposes of use or fields. In this case, the device may further include at least one of a sensor unit that senses state information of the device or surrounding the device, environment information and user information and a drive unit that moves robot joints and performs various other physical operations.

For example, a device may be an AI device such as a TV, a projector, a smartphone, a PC, a laptop, a terminal for digital broadcasting, a tablet PC, a wearable device, a set-top box (STB), a radio, a washing machine, a refrigerator, a digital signage, a robot, and a vehicle. In this case, the device may further include at least one of an input unit that obtains various types of data from outside, an output unit that generates outputs associated with sight, hearing, or touch, a sensor unit that senses state information of the device or surrounding the device, environment information and user information, and a training unit that uses learning data to learn a model consisting of artificial neural networks. The structure of the wireless device exemplified in FIG. 2 may be understood as a part of a RAN node (e.g., a base station, a DU, a RU, a RRH, etc.). That is, the device exemplified in FIG. 2 may be a RAN node. In this case, the device may further include a wired transceiver for front haul and/or back haul communication. However, in case the front haul and/or back haul communication is based on wireless communication, the at least one transceiver 206 exemplified in FIG. 2 may be used for the front haul and/or back haul communication, and no wired transceiver may be included.

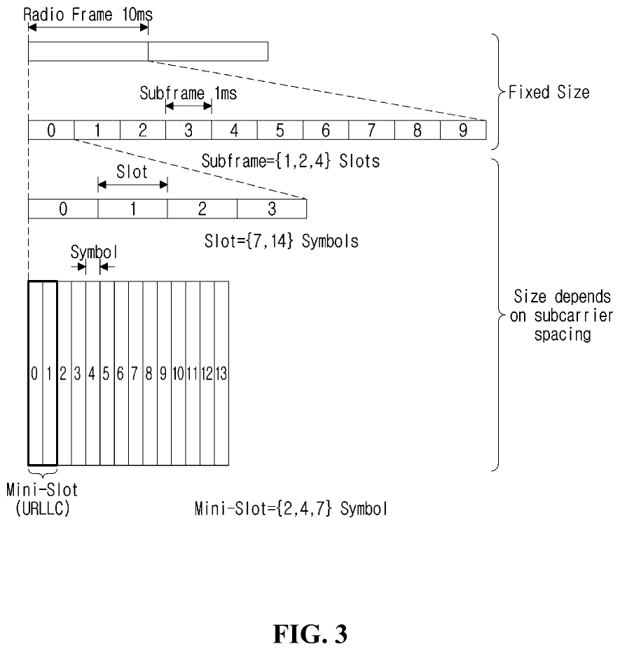

FIG. 3 exemplifies a frame structure in a wireless communication system to which the present disclosure may be applied.

A NR system may support a plurality of numerologies. Here, a numerology may be defined by a subcarrier spacing and a cyclic prefix (CP) overhead. Here, a plurality of subcarrier spacings may be derived by scaling a default (reference) subcarrier spacing by an integer N (or u). In addition, although it is assumed that a very low subcarrier spacing is not used in a very high carrier frequency, a numerology used herein may be selected independently from a frequency band. In addition, a variety of frame structures according to a plurality of numerologies may be supported in a NR system.

Hereinafter, an OFDM numerology and frame structure which may be considered in a NR system will be described. A plurality of OFDM numerologies supported in a NR system may be defined as in the following Table 1.

TABLE 1

| μ | Δf = 2^{μ} · 15[kHz] | CP |
|---|---|---|
| 0 | 15 | Normal |
| 1 | 30 | Normal |
| 2 | 60 | Normal, Extended |
| 3 | 120 | Normal |
| 4 | 240 | Normal |

NR supports a plurality of numerologies (or subcarrier spacings (SCS)) for supporting a variety of 5G services. For example, when a SCS is 15 kHz, a wide area in traditional cellular bands is supported, and when a SCS is 30 kHz/60 kHz, a dense-urban area, lower latency and a wider carrier bandwidth are supported, and when a SCS is 60 kHz or higher, a bandwidth wider than 24.25 GHz is supported to overcome a phase noise.

An NR frequency band is defined as a frequency range in two types (FRI, FR2). FRI and FR2 may be configured as in the following Table 2. In addition, FR2 may mean a millimeter wave (mmW).

TABLE 2

| Frequency Range | | | |
|---|---|---|---|
| designation | Corresponding frequency range | Subcarrier spacing | |
| FR1 | 410 MHz-7125 MHz | 15, 30, 60 | kHz |
| FR2 | 24250 MHz-52600 MHz | 60, 120, 240 | kHz |

Regarding a frame structure in an NR system, sizes of various fields in a time domain are expressed as multiples of a time unit of T_{c}=1/(Δfₘₐₓ·N) Here, Δfₘₐₓ is 480·10³ Hz and N_{f} is 4096. Downlink and uplink transmission is configured (organized) with a radio frame having a duration of T_{f}=1/(Δfₘₐₓ·N_{f}/100) T_{c}=10 ms. Here, the radio frame is configured with 10 subframes having a duration of T_{sf}=(Δfₘₐₓ·N_{f}/1000)T_{c}=1 ms, respectively. In this case, there may be one set of frames for an uplink and one set of frames for a downlink. In addition, transmission in an uplink frame No. i from a terminal should start earlier by T_{TA}=(N_{TA}+N_{TA,offset})T_{c} than a corresponding downlink frame in a corresponding terminal starts. For a subcarrier spacing configuration u, slots are numbered in an increasing order of n_{s,f}ⁿ∈{0, . . . , Nₛₗₒₜ^{subframe,μ}−1} in a subframe and are numbered in an increasing order of n_{s,f}ⁿ∈{0, . . . , Nₛₗₒₜ^{subframe,μ}−1} in a radio frame. One slot is configured with N_{symb}^{slot} consecutive OFDM symbols and N_{symb}^{slot} is determined according to CP. A start of a slot nₛ^{μ} in a subframe is temporally arranged with a start of an OFDM symbol nₛ^{μ}N_{symb}^{slot} in the same subframe. All terminals may not perform transmission and reception at the same time, which means that not all OFDM symbols of a downlink slot or an uplink slot are available.

Table 3 represents the number of OFDM symbols per slot (N_{symb}^{slot}), the number of slots per radio frame (Nₛₗₒₜ^{frame,μ}) and the number of slots per subframe (Nₛₗₒₜ^{subframe,μ}) in a normal CP and Table 4 represents the number of OFDM symbols per slot, the number of slots per radio frame and the number of slots per subframe in an extended CP.

TABLE 3

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 4

| μ | N_{symb}^{slot} | Nₛₗₒₜ^{frame, μ} | Nₛₗₒₜ^{subframe, μ} |
|---|---|---|---|
| 2 | 12 | 40 | 4 |

FIG. 3 is an example on μ=2 (SCS is 60 kHz), and referring to Table 3, 1 subframe may include 4 slots. 1 subframe={1,2,4} slot shown in FIG. 3 is an example, and the number of slots which may be included in 1 subframe is defined as in Table 3 or Table 4. In addition, a mini-slot may include 2, 4 or 7 symbols or more or less symbols.

Regarding a physical resource in a NR system, an antenna port, a resource grid, a resource element, a resource block, a carrier part and the like may be considered. Hereinafter, the physical resources which may be considered in an NR system will be described in detail.

First, in relation to an antenna port, an antenna port is defined so that a channel where a symbol in an antenna port is carried can be inferred from a channel where another symbol in the same antenna port is carried. When a large-scale property of a channel where a symbol in one antenna port is carried may be inferred from a channel where a symbol in another antenna port is carried, it may be said that the two antenna ports are in a quasi co-located or quasi co-location (QC/QCL) relationship. In this case, the large-scale property includes one or more of delay spread, doppler spread, frequency shift, average received power, and received timing.

In a 6G system, communication may be performed at the above-described THz band that is higher than millimeter wave (mmW) frequency, and the same frame structure as shown in FIG. 3 may be used or a separate frame structure for the 6G system may be used but is not limited to a specific form.

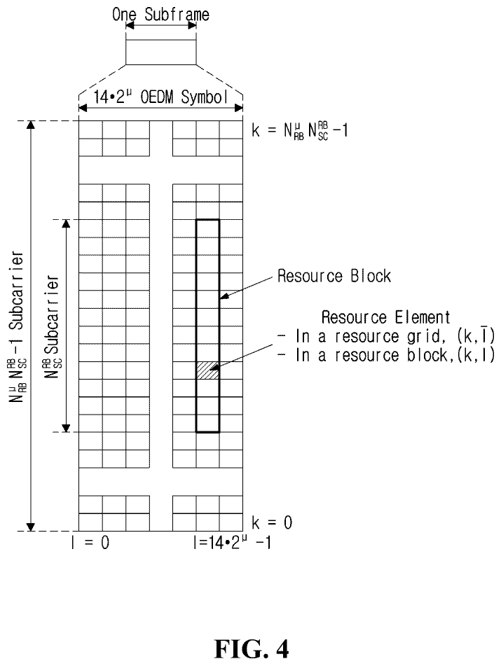

FIG. 4 exemplifies a resource grid in a wireless communication system to which the present disclosure may be applied.

Referring to FIG. 4, as an illustrative description, a resource grid is configured with N_{RB}^{μ}N_{SC}^{RB} subcarriers in a frequency domain, and one subframe is configured with 14·2^{μ} OFDM symbols, but the resource grid and the subframe are not limited thereto. In an NR system, a transmitted signal is described by one or more resource grids configured with 2^{μ}N_{symb}^{(μ)} OFDM symbols and N_{RB}^{μ}N_{SC}^{RB} subcarriers. Here, N_{RB}^{μ}≤N_{RB}^{max,μ}. The N_{RB}^{max,μ} represents a maximum transmission bandwidth, which may be different between an uplink and a downlink as well as between numerologies. In this case, one resource grid may be configured per u and antenna port p. Each element of a resource grid for μ and an antenna port p is referred to as a resource element and is uniquely identified by an index pair (k, l′). Here, k=0, . . . , N_{RB}^{μ}N_{SC}^{RB}−1 is an index in a frequency domain and l′=0, . . . , 2^{μ}N_{symb}^{(μ)}−1 refers to a position of a symbol in a subframe. When referring to a resource element in a slot, an index pair (k, l) is used. Here, l=0, . . . , 2^{μ}N_{symb}^{(μ)}−1. A resource element (k, l′) for μ and an antenna port p corresponds to a complex value, a_{k,f}^{(p,μ)}. When there is no risk of confusion or when a specific antenna port or numerology is not specified, indexes p and μ may be dropped, whereupon a complex value may be a_{k,l′}^{(p)} or a_{k,l′}. In addition, a resource block (RB) is defined as N_{sc}^{RB}=12 consecutive subcarriers in a frequency domain.

Point A plays a role as a common reference point of a resource block grid and is obtained as follows.
offsetToPointA for a primary cell (PCell) downlink represents a frequency offset between point A and a lowest subcarrier of a lowest resource block overlapping with a SS/PBCH block which is used by a terminal for initial cell selection. It is expressed in resource block units assuming a 15 kHz subcarrier spacing for FRI and a 60 kHz subcarrier spacing for FR2.
absoluteFrequency PointA represents a frequency-position of point A expressed as in an absolute radio-frequency channel number (ARFCN).

Common resource blocks are numbered from 0 to the top in a frequency domain for a subcarrier spacing configuration μ. The center of subcarrier 0 of common resource block 0 for a subcarrier spacing configuration u is identical to ‘point A’. A relationship between a common resource block number N_{CRB}^{μ} and a resource element (k, l) for a subcarrier spacing configuration u in a frequency domain is given as in the following Equation 1.

$${n}_{CRB}^{μ} = ⌊ \frac{k}{{N}_{s c}^{R B}} ⌋ \qquad [ Equation 1 ]$$

In Equation 1, k is defined relatively to point A so that k=0 corresponds to a subcarrier centering around point A. Physical resource blocks are numbered from 0 to N_{BWP,i}^{size,μ}−1 in a bandwidth part (BWP) and i is the number of a BWP. A relationship between a physical resource block n_{PRB} and a common resource block n_{CRB} in BWP i is given by the following Equation 2.

$${n}_{C R B}^{μ} = {n}_{P R B}^{μ} + {N}_{BWP , i}^{s t art , μ} \qquad [ Equation 2 ]$$

N_{BWP,i}^{start,μ} is a common resource block that a BWP starts relatively to common resource block 0.

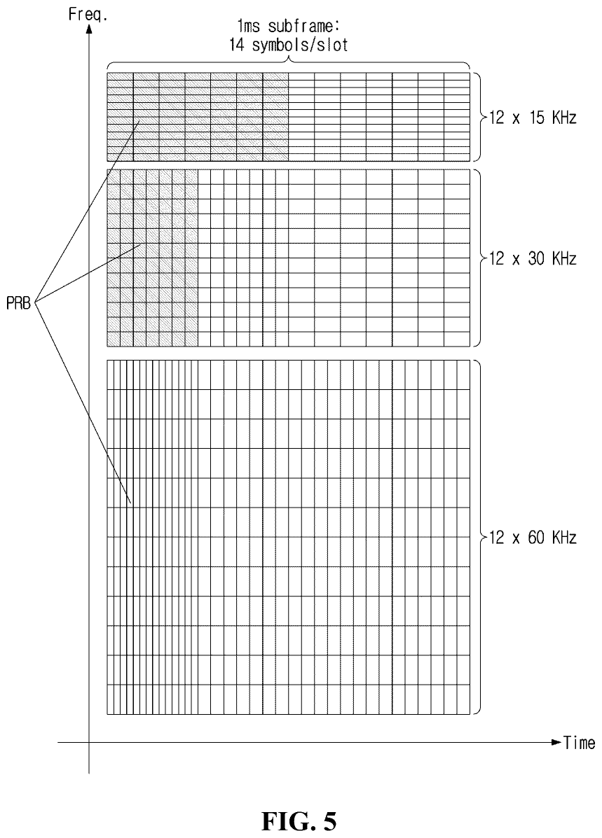

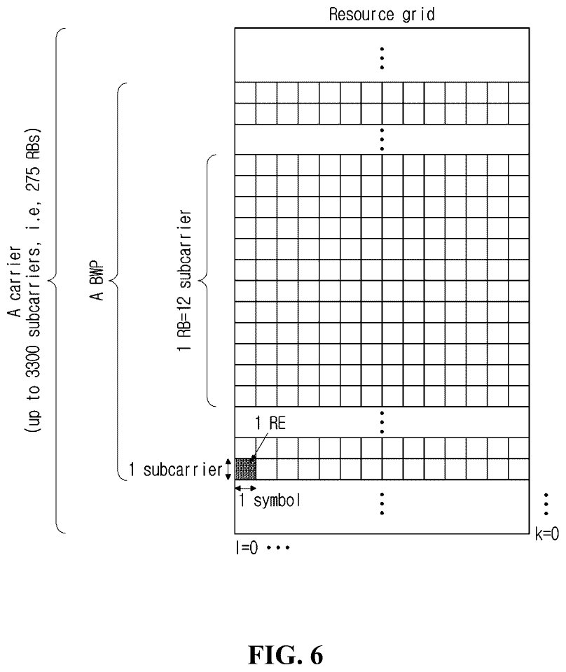

FIG. 5 exemplifies a physical resource block in a wireless communication system to which the present disclosure may be applied. In addition, FIG. 6 exemplifies a slot structure in a wireless communication system to which the present disclosure may be applied.

Referring to FIG. 5 and FIG. 6, a slot includes a plurality of symbols in a time domain. For example, for a normal CP, one slot includes 7 symbols, but for an extended CP, one slot includes 6 symbols.

A carrier includes a plurality of subcarriers in a frequency domain. A resource block (RB) is defined as a plurality of (e.g., 12) consecutive subcarriers in a frequency domain. A bandwidth part (BWP) is defined as a plurality of consecutive (physical) resource blocks in a frequency domain and may correspond to one numerology (e.g., an SCS, a CP length, etc.). A carrier may include a maximum of N (e.g., 5) BWPs. Data communication may be performed through an activated BWP and only one BWP may be activated for one terminal. In a resource grid, each element is referred to as a resource element (RE) and one complex symbol may be mapped.

In an NR system, up to 400 MHz may be supported per component carrier (CC). In case a terminal operating in such a wideband CC always operates with a radio frequency (FR) chip for the whole CC being turned on, terminal battery consumption may increase. Alternatively, when several application cases operating in one wideband CC (e.g., eMBB, URLLC, Mmtc, V2X, etc.) are considered, a different numerology (e.g., a subcarrier spacing, etc.) may be supported per frequency band in a corresponding CC. Alternatively, each terminal may have a different capability for the maximum bandwidth. In this regard, a base station may instruct a terminal to operate only in a partial bandwidth, not in an overall bandwidth of a wideband CC, and a corresponding partial bandwidth is defined as a bandwidth part (BWP) for convenience. A BWP may be configured with consecutive RBs on a frequency axis and may correspond to one numerology (e.g., a subcarrier spacing, a CP length, a slot/a mini-slot duration).

Meanwhile, a base station may configure a plurality of BWPs even in one CC configured for a terminal. For example, a BWP occupying a relatively small frequency domain may be configured in a PDCCH monitoring slot, and a PDSCH indicated by a PDCCH may be scheduled in a greater BWP. Alternatively, when UEs are congested in a specific BWP, some terminals may be configured with another BWP for load balancing. Alternatively, considering frequency domain inter-cell interference cancellation between neighboring cells and the like, some middle spectrums of a whole bandwidth may be excluded and BWPs on both edges may be configured in the same slot. In other words, a base station may configure at least one DL/UL BWP for a terminal associated with a wideband CC. A base station may activate at least one DL/UL BWP of configured DL/UL BWP(s) at a specific time (by L1 signaling or MAC control element (CE) or RRC signaling, etc.). In addition, a base station may indicate switching to another configured DL/UL BWP (by L1 signaling or MAC CE or RRC signaling, etc.). Alternatively, based on a timer, when a timer value is expired, it may be switched to a determined DL/UL BWP. Herein, an activated DL/UL BWP is defined as an active DL/UL BWP. However, a configuration on a DL/UL BWP may not be received when a terminal performs an initial access procedure or a RRC connection has not been set up yet, so a DL/UL BWP which is assumed by the terminal in such a situation is defined as an initial active DL/UL BWP.

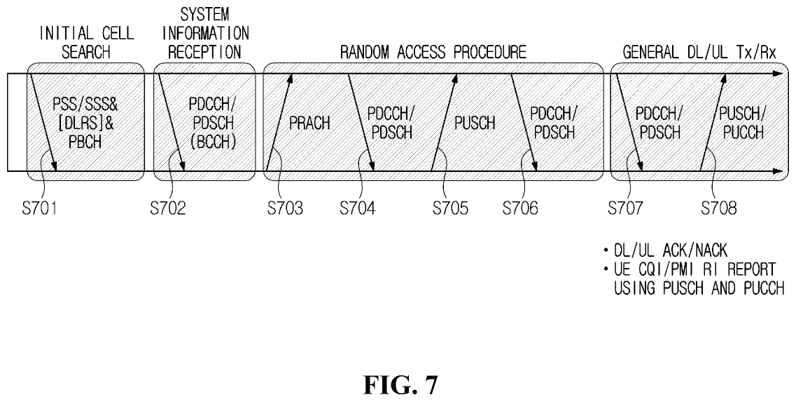

FIG. 7 exemplifies physical channels used in a wireless communication system, to which the present disclosure may be applied, and a general signal transmission and reception method using the physical channels.

In a wireless communication system, a terminal receives information from a base station through a downlink, and the terminal transmits information to the base station through an uplink. Information transmitted and received by the base station and the terminal includes data and a variety of control information, and a variety of physical channels exist according to a type/a usage of information transmitted and received by them.

When a terminal is turned on or newly enters a cell, the terminal performs an initial cell search including synchronization with a base station (S701). To this end, the terminal may synchronize with the base station by receiving a primary synchronization signal (PSS) and a secondary synchronization signal (SSS) from the base station and obtain information such as a cell identifier (ID) and the like. Next, the terminal may obtain broadcasting information in a cell by receiving a physical broadcast channel (PBCH) from the base station. Meanwhile, the terminal may check out a downlink channel state by receiving a downlink reference signal (DL RS) at the initial cell search step.

The terminal, which has completed initial cell search, may obtain more detailed system information by receiving a physical downlink control channel (PDCCH) and a physical downlink shared channel (PDSCH) according to information carried in the PDCCH (S702).

Meanwhile, in case the terminal accesses to the base station for the first time or does not have a radio resource for signal transmission, the terminal may perform a random access procedure (RACH) for the base station (S703 to S706). To this end, the terminal may transmit a specific sequence as a preamble through a physical random access channel (PRACH) (S703 and S705) and receive a response message for the preamble through a PDCCH and a corresponding PDSCH (S704 and S706). In the case of a contention-based RACH, a contention resolution procedure may be additionally performed.

The terminal, which has performed the above-described procedure, may subsequentially perform PDCCH/PDSCH reception (S707) and physical uplink shared channel (PUSCH)/physical uplink control channel (PUCCH) transmission (S708) as a general uplink/downlink signal transmission procedure. In particular, the terminal receives downlink control information (DCI) through a PDCCH. Herein, the DCI includes control information such as resource allocation information for the terminal and has a different format depending on its purpose of use.

Meanwhile, control information, which is transmitted by the terminal to the base station through an uplink or is received by the terminal from the base station, includes a downlink/uplink acknowledgement/non-acknowledgement (ACK/NACK) signal, a channel quality indicator (CQI), a precoding matrix indicator (PMI), a rank indicator (RI), and the like. For a 3GPP LTE system, the terminal may transmit control information of the above-described CQI/PMI/RI and the like through a PUSCH and/or a PUCCH.

### Concrete Embodiments of the Present Disclosure

Hereinafter, the present disclosure will describe a technology for simultaneously controlling a plurality of cells by using one physical downlink control channel (PDCCH) in a base station supporting carrier aggregation. Specifically, the present disclosure describes various embodiments in which a base station controls scheduling for transmission of a physical downlink shared channel (PDSCH) of a plurality of cells through one PDCCH. The plurality of cells may include at least one of a primary cell (Pcell), a secondary cell (Scell), a secondary Scell (sScell) or a primary Scell (pScell).

5G new radio (NR) is a technology of providing a service by the main technology such as enhanced mobile broadband (eMBB), ultra-reliable low-latency communications (URLLC) and massive IoT (mIoT). eMBB is a technology that has the main focus on speed improvement and transmits a lot of information by extending a spectrum from Long Term Evolution (LTE). eMBB is an important frequency merging technology that is frequently used in 5G NR.

Currently, 5G NR has the principle that, in each cell, a PDCCH of the cell performs scheduling for a PDSCH in charge of data transmission. That is, in order to trigger one PDSCH transmission, a base station should normally perform one scheduling through a PDCCH. In addition, in a carrier aggregation situation, that is, in a situation where a PDSCH is transmitted through a plurality of cells to improve data throughput from eMBB perspective, a base station should inform a terminal of scheduling information through a PDCCH according to each cell in order to simultaneously transmit the PDSCH through the plurality of cells. This is a basic operation that is performed since 4G LTE.

However, as supportable frequency bands increase in 5G NR, the number of cells used for carrier aggregation in 5G NR may be larger than the number of cells used for carrier aggregation in LTE. Accordingly, if an existing method for performing scheduling through a PDCCH according to each cell is applied to 5G NR as it is, a terminal consumes a lot of resources in decoding scheduling information.

Thus, hereinafter, the present disclosure proposes a method of performing scheduling for a PDSCH of a plurality of cells by using one PDCCH in one cell. In particular, the present disclosure proposes a technology of indicating modulation and coding scheme (MCS) information for PDSCHs of a plurality of cells in information on one PDCCH for a specific cell in order to transmit PDSCH scheduling information of a plurality of cells to a terminal.

Currently, in a PDCCH, MCS information for one cell is configured with 5 bits or 10 bits. Accordingly, when a base station performs simultaneous scheduling for PDSCHs of a plurality of cells by using one PDCCH, it is necessary that MCS information for the plurality of cells should be configured with bits corresponding to a multiple of existing bits (e.g., 5 bits or 10 bits). However, in this case, there may be a problem in that the number of bits occupied by MCS information in one PDCCH increases excessively. In particular, in 5G NR where the minimum transmission payload of a PDCCH is equal to or greater than 140 bits, simultaneous transmission of MCS information for a plurality of cells is fundamentally impossible. Furthermore, in comparison with multiple input multiple output (MIMO), frequency domain resource allocation (FDRA) or time domain resource allocation (TDRA) information, MCS information may not have any common feature that can be shared among cells. Accordingly, it may be said in principle that MCS information for each of a plurality of cells is separately indicated. Nevertheless, when MCS information for a plurality of cells is allocated to a small number of bits less than 5 bits or 10 bits, the problem of performance degradation, which may occur by PDCCH decoding in mobile broadband (MBB), is expected to be partially solved.

In order to perform simultaneous scheduling for PDSCH transmission for a plurality of cells by using one PDCCH for one cell in a carrier aggregation situation, the present disclosure will propose a method for minimizing a bit number of MCS information with no common feature sharable between cells or carriers in various fields related to PDSCH transmission included in one PDCCH. That is, the present disclosure will propose a method of minimizing a bit number of MCS information for a plurality of cells and allocating the MCS information to the plurality of cells or a plurality of carriers through one PDCCH.

Generally, an MCS of each cell or carrier may be expressed by one of 32 indexes. An index representing an MCS of each cell or carrier, that is, an MCS index may be expressed by 5 bits. When a base station spatially divides and transmits data by applying multiplexing of MIMO, two transport blocks (TBs) are delivered from a L2 MAC layer to a L1 layer simultaneously. In this case, respective MCS indexes for the two TBs should be notified to a terminal. Accordingly, a bit number of an MCS field according to each cell or carrier may become at least 5 bits and up to 10 bits. In the worst case, when 10 bits are used for each cell, if scheduling is performed for up to 4 scheduled component carriers in one PDCCH, MCS information in one PDCCH may become up to 40 bits (10 bits×4 (=number of CCs)). This corresponds to about 30% of 140 bits that are a maximum payload bit number available in one PDCCH. Generally, one PDCCH may include not only an MCS index but also various fields like MIMO, FDRA or TDRA. Accordingly, it is not desirable that a large number of bits are used to allocate MCS information for a plurality of cells in one PDCCH. The present disclosure will propose various methods capable of PDSCH scheduling for a plurality of cells (e.g., 4 CCs) by using a much smaller number of bits than the above-described number of bits. In the present disclosure, CC may be understood as an active bandwidth part (active BWP) or a cell that is configured and/or indicated in the CC.

In various methods proposed herein, how downlink control information (DCI) field information of a PDCCH is applied to a scheduled CC may be distinguished as shown in Table 5 below. Table 5 exemplifies the features of fields in one PDCCH for multi-CC scheduling.

TABLE 5

| | Processing method | |
|---|---|---|
| NNo. | according to each field | Comment |
| 1 | Shared-reference-CC | In this method, a value indicated by a DCI field is applied |
| | | only to a specific one reference CC, and a specific default |
| | | value is applied to the remaining CCs. The reference CC |
| | | may be a DCI scheduling CC, a CC with a lowest index, |
| | | or a CC pointed by a carrier indicator field (CIF). |
| 2 | Shared-single-CC | In this method, a DCI field is present only when there is |
| | | only one scheduled CC, and the DCI field is omitted when |
| | | there are a plurality of scheduled CCs. |
| 3 | Shared-table-extension | In this method, each row of a table indicated by a DCI |
| | | field is configured with a combination of information on a |
| | | plurality of CCs. |
| 4 | Shared-common | In this method, a value indicated by a DCI field is |
| | | commonly applied to every scheduled CC. |
| 5 | Separate-equal | In this method, a DCI field with a same size is separately |
| | | applied to each scheduled CC/TB. |
| 6 | Separate-delta | In this method, a DCI field is separately configured |
| | | according to each scheduled CC/TB, full information is |
| | | indicated only for a specific reference CC/TB, and delta |
| | | information representing a difference from the full |
| | | information is indicated for the remaining CCs. |
| 7 | Omit | DCI field itself is omitted. |

Table 5 shows feature categories applicable to various fields. For MCS information, various options may be proposed according to which method is applied.
1) Option-1: separate-equal
   The number of MCS indexes indicating MCS is changed according to the number of scheduled CCs.
   This method changes the size of an MCS table.
2) Option-2: shared-common
   This method configures information on carriers or cells sharing same MCS information in advance.
3) Option-3: a method of applying separate-equal among cells and applying shared-common among TBs.
4) Option-4: separate-delta
   A difference from an indicated MCS index is indicated to a reference CC.
   One common MCS index is indicated within a group (or subset) of a plurality of cells.
5) Option-5: a method of applying separate-equal among cells and applying separate-delta among TBs.

In the present disclosure, in order to reduce DCI overhead required for scheduling of a PDCSH and/or physical downlink shared channel (PUSCH) in a carrier aggregation situation with a plurality of cells being configured, it is possible to consider a multi-cell scheduling method that schedules a plurality of serving cells and/or CCs by a single piece of DCI and PDSCH/PUSCH transmission through them based on justification as shown in Table 6 of Rel-18 below.

TABLE 6
NR supports a wide range of spectrum in different frequency ranges. It is expected that
there will be increasing availability of spectrum in the market for 5G Advanced possibly
due to re-farming from the bands originally used for previous cellular generation
networks. Especially for low frequency FR1 bands, the available spectrum blocks tend
to be more fragmented and scattered with narrower bandwidth. For FR2 bands and some
FR1 bands, the available spectrum can be wider such that intra-band multi-carrier
operation is necessary. To meet different spectrum needs, it is important to ensure that
these scattered spectrum bands or wider bandwidth spectrum can be utilized in a more
spectral/power efficient and flexible manner, thus providing higher throughput and
decent coverage in the network.
One motivation is to increase flexibility and spectral/power efficiency on scheduling data
over multiple cells including intra-band cells and inter-band cells. The current scheduling
mechanism only allows scheduling of single cell PUSCH/PDSCH per a scheduling
DCI. With more available scattered spectrum bands or wider bandwidth spectrum, the
need of simultaneous scheduling of multiple cells is expected to be increasing. To reduce
the control overhead, it is beneficial to extend from single-cell scheduling to multi-cell
PUSCH/PDSCH scheduling with a single scheduling DCI. Meanwhile, trade-off between
overhead saving and scheduling restriction has to be taken into account.

Hereinafter, for a structure design of DCI performing the above-described multi-cell scheduling, that is, multi-cell DCI (MC-DCI), the present disclosure describes various embodiments of the configuration and interpretation of an FDRA field within the DCI. A multi-cell scheduling operation for PDSCH transmission or PUSCH transmission described in the present disclosure may also be applied to multi-cell scheduling for PUSCH transmission or PDSCH transmission, respectively, in a same or similar manner. In addition, in the present disclosure, a component carrier (CC) may be understood as an active bandwidth part (active BWP) or a cell that is configured and/or indicated in the CC. Hereinafter, in the present disclosure, a scheduled CC may be referred to as a co-scheduled CC. In addition, in the present disclosure, when cell grouping is performed for a plurality of cells included in scheduled CCs, one group may be referred to as a cell subgroup.

Hereinafter, the present disclosure will propose various options that enable PDSCH scheduling for a plurality of CCs by defining a structure and a procedure so that a DCI field of a PDCCH for multi-carrier scheduling can use not a multiple of CCs but a minimum bit number, in a current DCI structure of a PDCCH where an MCS field occupies at least 5 bits and up to 10 bits depending on the number of TBs in each CC. Herein, the following basic operations may be assumed. According to various embodiments of the present disclosure, the basic operations are as follows.
A. a group of CCs sharing information on an MCS, that is, a subset may be determined beforehand in a higher layer (e.g., a RRC layer or a MAC layer). For example, a group of intra-band CCs, a group of inter-band CCs, or a group of CCs according to same sub-carrier spacing (SCS) or each resource allocation (RA) type may be determined in advance. Herein, only one group may be formed, and this means that there is no subgrouping.
B. basic information of an MCS to be shared may be provided semi-statically in a MAC layer or be pre-configured in a RRC layer. In addition, delta information or additional information for the MCS may be indicated through DCI.
C. a maximum number of co-schedulable CCs is not limited in principle. However, for convenience of explanation, the present disclosure assumes that the maximum number of CCs is 4. However, the present disclosure may be applied likewise to a case where the number of CCs is equal to or greater than 4. In addition, various embodiments may be applied both to an MCS of downlink and to an MCS of uplink.
D. a base station may notify which of the options is to be used according to situations to a terminal through RRC signaling. That is, when there are dozens of schedulable CCs, the base station may consider grouping CCs according to each option.
E. when various MCS tables for ultra-reliable low-latency communications (URLLC) are applied to all CCs that are scheduled using multi-cell DCI (MC-DCI), MC-DCI may be cyclic redundancy check (CRC)-scrambled using an MCS-cell-radio network temporary identifier (MCS-C-RNTI) and a cell-radio network temporary identifier (C-RNTI). For cells that are scheduled using MC-DCI, a plurality of MCS tables may be configured to be operable by an MCS-C-RNTI. When signaling is performed through an MC-DCI scrambled with an MCS-C-RNTI without configuration of a plurality of MCS tables, a corresponding cell is handled as not actually scheduled. Additionally, the MC-DCI may be restricted to be scrambled only using a C-RNTI.

For multi-carrier scheduling, an MCS-multi cell (MC)-RNTI corresponding to an MCS-C-RNTI may be defined. That is, in the case of multi-cell carrier aggregation, MCSs of all aggregated carriers may be configured as general-purpose MCSs for URLCC, and an MCS-MC-RNTI may be used to indicate such a situation. Similarly, an MC-RNTI corresponding to a C-NRIT may be used. That is, in order to indicate that multiple carriers are scheduled by MC-DCI, a RNTI may be defined for multi-carrier scheduling. In case a RNTI is defined for MC-DCI, DCI for scheduling one cell and DCI for scheduling multiple carriers may be discriminated.

F. at least one MCS table may be configured for each cell. Herein, a cell, for which two tables are configured, and a cell, for which one MCS table is configured, may be included in one CC group. When MC-DCI for the CC group is scrambled using an MCS-C-RNTI, among cells belonging to the CC group, a cell, for which no MCS table for URLCC is configured, may be handled as not scheduled. According to an embodiment, when a plurality of CCs are grouped, a rule of restricting cells, for which a plurality of MCS tables are configured, to be included in one CC group may be defined.

G. when a cell with a feature of URLLC and a cell without feature of URLLC are included in a CC group where they are scheduled together, a rule of restricting MC-DCI to be scheduled only by a C-RNTI and an MCS-C-RNTI to be used only for single cell scheduling may be defined. That is, a rule may be defined so that when a single cell is scheduled by MC-DCI, an MCS-C-RNTI is used, and when two or more cells are scheduled by MC-DCI, a C-RNTI is used. Alternatively, a rule may be defined so that when a single cell is scheduled by MC-DCI, an MCS-MC-RNTI is used, and when two or more cells are scheduled by MC-DCI, a MC-RNTI is used. Furthermore, among scheduled CCs, cells sharing a DCI field may be grouped into a cell group. For example, scheduled CCs may be grouped based on a sharable DCI field.

H. a base station may notify to a terminal and/or configure beforehand, through RRC signaling, which of various options to be described below is to be used.

I. in the present disclosure, a CIF may be used to indicate validity or the number of cells of a cell group. According to other embodiments, a new DCI field may be defined to indicate the validity or the number of cells. The new DCI field may be defined in a size equal to or larger than 3 bits.

### Option-1: Separate-Equal (the Number of MCS Indexes Indicating an MCS is Changed According to the Number of Scheduled CCs)

Hereinafter, Table 7 shows an existing 5G NR MCS table. Hereinafter, Table 7 shows modulation orders Qₘ, TBS indexes, and redundancy versions rV_{idx} corresponding to the existing 32 pieces of MCS index information.

TABLE 7

| MCS | Modulation | TBS | Redundancy |
|---|---|---|---|
| Index I_{MCS} | Order Qₘ | Index I_{TBS} | Version rv_{idx} |
| 0 | 2 | 0 | 0 |
| 1 | 2 | 1 | 0 |
| 2 | 2 | 2 | 0 |
| 3 | 2 | 3 | 0 |
| 4 | 2 | 4 | 0 |
| 5 | 2 | 5 | 0 |
| 6 | 2 | 6 | 0 |
| 7 | 2 | 7 | 0 |
| 8 | 2 | 8 | 0 |
| 9 | 2 | 9 | 0 |
| 10 | 2 | 10 | 0 |
| 11 | 4 | 10 | 0 |
| 12 | 4 | 11 | 0 |
| 13 | 4 | 12 | 0 |
| 14 | 4 | 13 | 0 |
| 15 | 4 | 14 | 0 |
| 16 | 4 | 15 | 0 |
| 17 | 4 | 16 | 0 |
| 18 | 4 | 17 | 0 |
| 19 | 4 | 18 | 0 |
| 20 | 4 | 19 | 0 |
| 21 | 6 | 19 | 0 |
| 22 | 6 | 20 | 0 |
| 23 | 6 | 21 | 0 |
| 24 | 6 | 22 | 0 |
| 25 | 6 | 23 | 0 |
| 26 | 6 | 24 | 0 |
| 27 | 6 | 25 | 0 |
| 28 | 6 | 26 | 0 |
| 29 | Reserved | | 1 |
| 30 | | | 2 |
| 31 | | | 3 |

Referring to Table 7, 32 MCS indexes are available, and one of the indexes defined in the table may be indicated by a DCI filed. When one TB is transmitted, one MCS index may be transmitted in a DCI field of a PDCCH, and when two TBs are transmitted, two MCS indexes may be transmitted. Accordingly, if the number of CCs increases, the number of MCS indexes to be transmitted also increases. For example, for MCS information, two TBs per CC, that is, a maximum of CC×2×5 bits may be required in MC-DCI. Accordingly, the present disclosure proposes methods of controlling a plurality of cells through usage of a DCI field of one PDCCH by operating a small-sized new MCS table, which is defined by modifying the MCS Table 7 or by extracting a portion of the MCS Table 7, or by grouping indexes and using the indexes with a group ID.

Hereinafter, various methods for scheduling PDSCHs of a plurality of CCs with a small number of bits in MC-DCI within a PDCCH by reducing the number of MCS indexes as compared with an existing MCS table will be described. Herein, the bit number of an MCS index may be modified according to the number of CCs.
1-1. A new MCS table with a reduced number of indexes as compared with the existing MCS table used for single cell scheduling may be defined. The new MCS table may be a small-sized table in which a modulation order of an index, a TBS index and redundancy versions are reconfigured based on the existing MCS table. The MCS table may include only lowest N indexes or highest M indexes among a total of N MCS indexes in the existing MCS table. Which table is to be used may be dynamically or statically notified through MC-DCI, media access control (MAC) control element (CE) or radio resource control (RRC) signaling according to an SNR of a current cell or carrier.

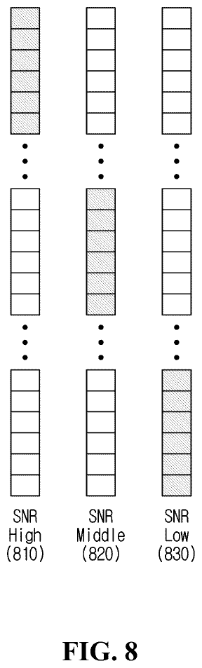

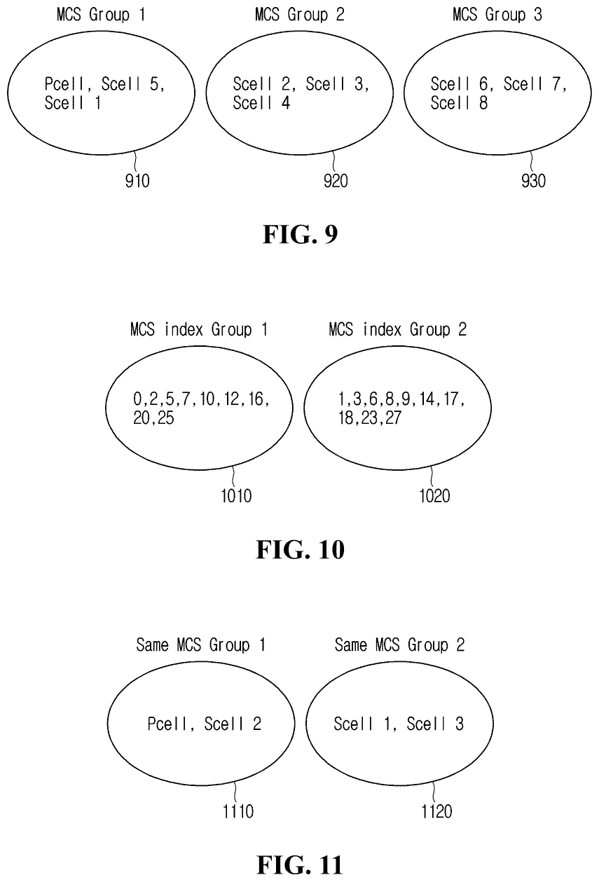

FIG. 8 illustrates examples of MCS tables according to channel quality in a wireless communication system according to an embodiment of the present disclosure. Referring to FIG. 8, when channel quality (e.g., a signal to noise ratio (SNR)) is greater than a first threshold, that is, in the case of SNR High 810, a new MCS table may consist only of lowest M indexes among a total of N MCS indexes of an existing MCS table. When the SNR is smaller than or equal to the first threshold and is greater than a second threshold, that is, in the case of SNR Middle 820, the MCS table may consist only of middle M indexes among the total of N MCS indexes of the existing MCS table. In addition, when the SNR is smaller than or equal to the second threshold, that is, in the case of SNR Low 830, the new MCS table may consist only of highest M indexes among the total of N MCS indexes of the existing MCS table.
1-2. No new MCS table is defined, but some indexes from an existing MCS table may be reused. Herein, the number of bits of MCS indexes may be changed according to the number of CCs that are scheduled in MC-DCI.
1-2-1. According to an embodiment, only even-numbered indexes or odd-numbered indexes from the existing MCS table may be used. In this case, when an MCS index 10 is indicated for a specific CC, the index 10 may be mapped to an MCS index 20, 21 or 19 of the existing MCS table.
1-2-2. According to an embodiment, as many indexes as a multiple of a specific number (e.g., 3 or 4) may be used according to the number of scheduled CCs. That is, as the number of scheduled CCs increase, per-CC bits should be further reduced, and thus only a smaller number of indexes may be mapped to new indexes. Thus, the number of bits of MCS used for each CC may be flexibly changed according to the number of scheduled CCs.
1-3. Schedulable CCs are grouped into a plurality of groups by using MC-DCI, and a same MCS table and a new mapping method may be applied to each group.
1-3-1. Among CCs to be scheduled, CCs within a band or CCs having a RF frequency band with a similar feature may be grouped into a same group. The above-described method of defining a new MCS table or of selectively using an existing MCS index according to the number of scheduled CCs may be applied to CCs that belong to a same group.
1-3-2. When there are a plurality of groups, an MCS field of MC-DCI may include a group ID.
1-3-3. Cells using a same MCS table and a same index mapping method may be preconfigured as one MCS group and be notified to a terminal. For example, an MCS group as shown in FIG. 9 may be preconfigured in RRC or be semi-statically configured in MAC and then be notified to a terminal.

FIG. 9 illustrates an example of MCS grouping for multi-carrier scheduling in a wireless communication system according to an embodiment of the present disclosure. Referring to FIG. 9, Pcell, Scell5 and Scell1 are included in an MCS Group 1 910, Scell2, Scell3 and Scell4 are included in an MCS Group 2 920, and Scell6, Scell7 and Scell8 are included in an MCS Group 3 930. For cells belonging to a same MCS group, a same MCS table and a same index mapping method may be applied. For example, Pcell, Scell5 and Scell1 of the MCS Group 1 910 follow a same MCS table. Herein, an MCS group may be understood as a cell group using a same MCS table.
1-4. Some indexes of an MCS table may be grouped into new MCS index groups, and indexes of each MCS index group may be mapped to each CC.

FIG. 10 illustrates an example of an MCS index group in multi-carrier scheduling in a wireless communication system according to an embodiment of the present disclosure. Referring to FIG. 10, some index numbers from an existing MCS table may be set to a new MCS index group. For example, indexes 0, 2, 5, 7, 10, 12, 16, 20 and 05 from the existing MCS table may be configured as an MCS index group 1 1010, and indexes 1, 3, 6, 8, 9, 14, 17, 18, 23 and 27 from the existing MCS table may be configured as an MCS index group 2 1020. New MCS index groups may be preconfigured in RRC. Herein, which indexes from the existing MCS table are to be included in a single MCS index group may be determined according to a feature of CCs and the number of CCs. Furthermore, when a plurality of MCS index groups are configured, an MCS field of MC-DCI may further include a group ID.

Specifically, when the number of MCS indexes included in a full MCS table used in DCI for single-cell scheduling is N, MCS information of cells scheduled through MC-DCI may be indicated based on a reduced MCS table including M MCS indexes. Herein, the MCS information of the cells scheduled through MC-DCI may include an MCS value for each of a plurality of cells and/or an MCS value for each TB transmitted through a PDSCH of the plurality of cells. The number of MCS indexes M of the reduced MCS table may have a smaller value than N, which is the number of MCS indexes included in the full MCS table.

According to an embodiment, M MCS indexes may be lowest M or highest M indexes among N MCS indexes in an existing full MCS table. According to an embodiment, M MCS indexes may be indexes corresponding to multiples of K among N MCS indexes in an existing full MCS table. Herein, K may be 0 or a positive integer. For example, if K is 2, M MCS indexes may be multiples of 2, that is, 2, 4, 6, 8, 10, . . . , 30. According to an embodiment, among N MCS indexes in an existing full MCS table, M MCS indexes may include indexes corresponding to numbers that are obtained by adding a specific offset to multiples of K. For example, if K is 3 and the offset is 1, M MCS indexes may be 4, 7, 10, 13, . . . 31. According to an embodiment, M MCS indexes may be determined directly by a base station. The above-described reduced MCS table may be applied to a case where a plurality of cells are scheduled by using MC-DCI. An existing full MCS table may be applied to a case where scheduling is performed for a single cell through MC-DCI or for each TB transmitted through a PDSCH in a single cell.

As described above, when separate values for multi-cell scheduling are set for each cell and/or each TB in an MCS field within MC-DCI, a size of the MCS field may be determined as follows.

First, the size of an MCS field in DCI for the existing single-cell scheduling may be set to L=ceil {log 2(N)} bit. Herein, the size of the MCS field may be a size in a situation where N (e.g., about 32) MCS states and/or MCS indexes are set to be possible to indicate through the MCS field. L may be set to a same value or different values for cells. For example, L may be 5.

Meanwhile, if an MCS field in MC-DCI for multi-cell scheduling includes separate values for each cell and each TB, a maximum value of a plurality of L_sum values for each of a plurality of co-scheduled cell sets may be determined as the size of the MCS field in MC-DCI. Herein, the co-scheduled cell sets mean combinations of cells that are scheduled together through the same MC-DCI. A co-scheduled cell set may be configured based on a schedulable cell set through MC-DCI. A schedulable cell set means a set including every cell that is schedulable through MC-DCI. In addition, L_sum means a sum of L values in each TB according to a maximum number of transmissible TBs configured in each cell belonging to a co-scheduled cell set.

For example, for a schedulable cell set {cell 1, cell2, cell3}, two co-scheduled cell sets #1 and #2 may be configured as {cell 1, cell2} and {cell2, cell3} respectively. In this case, maximum numbers of transmissible TBs according to each PDSCH and/or PUSCH configured in cell1, cell2 and cell3 are 1, 1 and 2 respectively, and if L is 5 bits, L_sum of the co-scheduled cell set #1 is calculated to be 10 bits, and L_sum of the co-scheduled cell set #2 is calculated to be 15 bits. Accordingly, the size of an MCS field in MC-DCI may be determined as 15 bits.

### Option-2: Shared-Common

The shared-common method is a method of applying a same MCS index to all of a plurality of CCs or applying a same MCS index to CCs or cells belonging to a specific group. Herein, the CCs or cells belonging to the specific group may have a same group ID. In other words, the shared-common method is not a method of providing an MCS index to each CC like Option-1 but a method of providing a same and one MCS index to a plurality of CCs.

FIG. 11 illustrates an example of a cell group using a same MCS index in a wireless communication system according to an embodiment of the present disclosure. Referring to FIG. 11, a base station may group, among a plurality of cells, cells capable of sharing a same MCS index into a cell group or a cell subgroup using a same MCS and transmit a group ID and an MCS index through MC-DCI for scheduling for a plurality of cells. For example, an MCS group 1 1110 may include Pcell and Scell2, and an MCS group 2 1120 may include Scell1 and Scell3. In this case, the base station may indicate an MCS index for a plurality of CCs by a smaller number of bits than when transmitting an MCS index according to each CC. Herein, each group of cells may be preconfigured in a RRC layer of the base station or may be semi-statically configured in a MAC CE.

Specifically, the base station may configure an MCS field including one MCS index within MC-DCI for scheduling a plurality of cells. Herein, the MCS index indicated through the MCS field may be commonly applied to all of a plurality of cells or all of a plurality of TBs that are transmitted through a PDSCH in the plurality of cells. As described above, when a plurality of cell groups sharing one MCS field are configured, the base station may configure and/or indicate a shared MCS field and/or shared MCS information for each of the cell groups. A cell group sharing one MCS field may include cells to which an MCS index indicated through one MCS field in MC-DCI is commonly applied. According to an embodiment, an MCS table corresponding to a shared MCS field of each cell group may be configured in a reduced MCS table form as described above. Herein, whether or not to use an MCS for URLCC may be identified by a RNTI, and a rule may be defined to restrict a cell group to consist of cells capable of modifying the MCS in real time.

As described above, a base station may configure an MCS field in MC-DCI by applying the shared-common method to each cell group or each cell subgroup belonging to a co-scheduled cell set. That is, according to each cell group/each subgroup or according to each TB index, one MCS field is configured, and an MCS index indicated through one MCS field may be commonly applied to cells belonging to the cell group/subgroup or to the TBs.

A co-scheduled cell set may include at least one 1-TB cell and at least one 2-TB cell. A 1-TB cell is a cell that transmits one TB through a PDSCH, and a 2-TB cell is a cell that transmits two TBs through a PDSCH.

According to an embodiment, a rule may be defined to restrict one cell group to consist only of a 1-TB cell or a 2-TB cell. That is, when determining cells belonging to a co-scheduled cell set, a base station may put a restriction that the 1-TB cell and the 2-TB cell do not belong to a same cell group. If a cell group includes only 2-TB cells, the base station may configure and/or indicate an MCS filed and/or MCS information commonly applied to a plurality of cells according to each TB index of 2-TB cells. Alternatively, if a cell group includes only 2-TB cells, the base station may configure and/or indicate an MCS filed and/or MCS information to be commonly applied to all TB indexes of the 2-TB cells.

According to an embodiment, one cell group may be allowed to include a 1-TB cell and a 2-TB cell. That is, when determining cells belonging to a co-scheduled cell set, a base station may include a 1-TB cell and a 2-TB cell in a same cell group. When the 1-TB cell and the 2-TB cell are included in the cell group, the base station may configure and/or indicate a first MCS field and/or first MCS information to be commonly applied to a TB1 index of the 2-TB cell and a single TB of the 1-TB. In addition, the base station may configure and/or indicate a second MCS field and/or second MCS information commonly applied to a TB2 index of the 2-TB cell. Alternatively, when the 1-TB cell and the 2-TB cell are included in the cell group, the base station may configure and/or indicate an MCS field and/or MCS information to be commonly applied to all TB indexes of the 1-TB cell and the 2-TB cell.

A 1-table cell with one MCS table being configured and a 2-table cell with two MCS tables being configured may be included in a co-scheduled cell set. The 1-table cell is a cell in which an MCS table indicated through a C-RNTI based PDCCH is configured, and the 2-table cell is a cell in which a first MCS table indicated through a C-RNTI based PDCCH and a second MCS table indicated through an MCS-C-RNTI based PDCCH are configured.

According to an embodiment, a rule may be defined to restrict one cell group to consist only of a 1-table cell or only of a 2-table cell. That is, when determining a co-scheduled cell set, a base station may restrict the 1-table cell and the 2-table cell from belonging to a same cell group.

According to an embodiment, one cell group may be allowed to include a 1-table cell and a 2-table cell. That is, when determining a co-scheduled cell set, a base station may include the 1-table cell and the 2-table cell in a same cell group.

According to an embodiment, when both a 1-table cell and a 2-table cell are included in a co-scheduled cell set, a base station may indicate an MCS index by using MC-DCI in a C-RNTI based PDCCH. That is, for a co-scheduled cell set including both the 1-table cell and the 2-table cell, a rule may be defined to restrict scheduling through MC-DCI in an MCS-C-RNTI based PDCCH from being allowed.

According to an embodiment, for a co-scheduled cell set including both a 1-table cell and a 2-table cell, scheduling through MC-DCI in an MCS-C-RNTI based PDCCH may be allowed. In this case, for the 1-table cell, a terminal may perform PDSCH and/or PUSCH transmission/reception by interpreting and applying a value indicated by an MCS field in the MC-DCI as an MCS index of an MCS table corresponding to a C-RNTI based PDCCH or by considering or assuming that there is no scheduling.

According to an embodiment, one cell group may include a 1-table cell and a 2-table cell. That is, when determining a co-scheduled cell set, a base station may include the 1-table cell and the 2-table cell in a same cell group. When both the 1-table cell and the 2-table cell are included in one cell group, the base station may indicate an MCS index by using MC-DCI in a C-RNTI based PDCCH. That is, for the cell group including both the 1-table cell and the 2-table cell, a rule may be defined to restrict scheduling through MC-DCI in an MCS-C-RNTI based PDCCH from being allowed. According to an embodiment, for a cell group including both a 1-table cell and a 2-table cell, if scheduling through MC-DCI in an MCS-C-RNTI based PDCCH is allowed, a base station and/or a terminal may perform PDSCH and/or PUSCH transmission/reception by considering or assuming that there is no scheduling for the 1-table cell.

### Option-3: A Method of Applying Separate-Equal Among Cells and Applying Shared-Common Among TBs

In one cell, two TBs, that is, 2-TB may be transmitted. In one cell, transmission of 2-TB may deliver more data than transmission of 1-TB. This matter is related to MIMO, and when 2-TB is transmitted in one cell, an MCS index of each TB is required. Accordingly, the present disclosure proposes a method for reducing an MCS bit number for TBs of a plurality of cells, while reducing an MCS bit number for the plurality of cells.
3-1. According to an embodiment, the method of Option-1 may be applied among cells, and a same MCS index may be applied to 2 TBs when each of the cells uses 2-TB.
3-2. If there is no significant difference of MCS index between 2-TB, it may be processed by an internal implementation of a base station.
3-3. According to an embodiment, a maximum number of TBs per cell may be preset by a base station, and the maximum number of TBs per cell may be limited in a higher layer. In this case, a rule may be defined to restrict cell grouping based on the number of TBs per cell.

Specifically, a base station may apply the above-described method of Option-2 to two TBs that are transmitted through a same PDSCH of a same cell. That is, the base station may configure and/or indicate one shared MCS field and/or shared MCS information for the two TBs. In addition, the base station may configure and/or indicate a separate shared MCS field and/or separate shared MCS information for each cell according to the method of Option-1. Herein, an MCS table corresponding to the separate shared MCS field may be a reduced MCS table.

According to an embodiment, the above-described method may be applied to a case in which a plurality of cells are scheduled through MC-DCI, and when only one cell is scheduled through MC-DCI, separate MCS values may be configured according to each TB, and the separate MCS values according to each TB may be indicated to a terminal. At this time, an MCS table corresponding to the separate MCS values according to each TB may be a full MCS table. Herein, if CCs within a group have different numbers of TBs, that is, if a 2-TB cell and a 1-TB cell belong to one group, only one of TB1 and TB2 of the 2-TB cell may be configured to share an MCS field with the 1-TB cell. If the CCs within the group have a same number of TBs, TBs with a same index may share a same MCS value.

According to an embodiment, the number of TBs of cells within a group may be limited to 1 or 2. This aims to prevent complexity from increasing when many cells and many TBs are scheduled together in a base station. That is, in order to reduce scheduling complexity for a plurality of cells, a maximum number of TBs per cell may be limited. In this case, cell grouping for the plurality of cells may be performed based on the maximum number of TBs.

### Option-4: Separate-Delta

The above-described method of Option-1 does not use all the indexes of a full MCS table but uses only some of the indexes, and the method of Option-2 does not reflect any difference between CCs but processes the CCs averagely. However, when 5-bit MCS values are connected in parallel and are used, there may be a problem in that the bit share of an MCS field in MC-DCI excessively increases. Accordingly, hereinafter, the present disclosure proposes a method of using an existing full MCS index table as it is while reducing an amount of MCS information.
4-1. A reference CC may be configured in a higher layer, and delta information for the remaining CCs may be indicated through MC-DCI. Herein, the MCS information bits of the reference CC may be 5 bits, and the MCS information bits of the remaining CCs may be 3 bits.

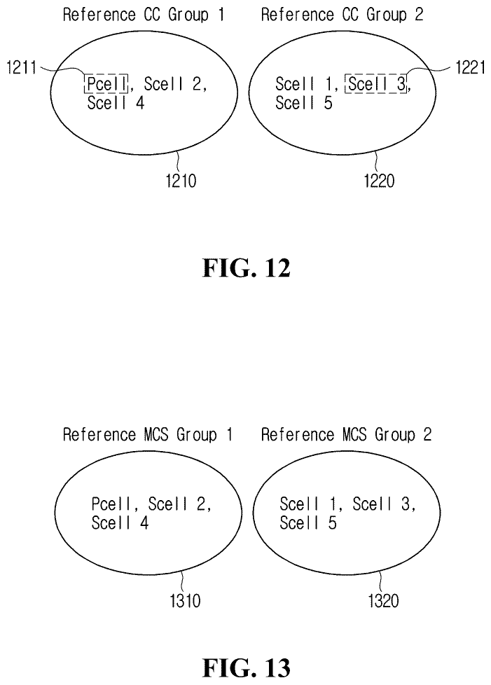

FIG. 12 illustrates an example of MCS-based delta operation of a reference CC in a wireless communication system according to an embodiment of the present disclosure. Referring to FIG. 12, a reference CC of a reference CC group 1 1210 is Pcell 1211, and a reference CC of a reference CC group 2 is Scell3 1221. Accordingly, for Pcell 1211 and Scell3 1221 that are reference CCs, an MCS index may be indicated using 5 bits, and for the remaining CCs, that is, Scell2 and Scell4 of the reference CC group 1 1210 and Scell1 and Scell5 of the reference CC group 2 1220, a delta value may be indicated using 2 bits or 3 bits, which is smaller than 5 bits.
4-2. A base station may indicate, to a terminal, a reference MCS index through a MAC CE or RRC and delta information of every CC by using MC-DCI. Herein, the delta information may represent a difference between the reference MCS index of a reference CC and an MCS index of each of the remaining CCs. According to an embodiment, the reference MCS index may be included in the MC-DCI. In this case, the MC-DCI may include 5-bit reference MCS index information and 3-bit per-CC delta information.

FIG. 13 illustrates an example of reference MCS-based delta operation in a wireless communication system according to an embodiment of the present disclosure. Referring FIG. 13, unlike FIG. 12, there is no reference CC. That is, FIG. 13 exemplifies a case in which delta information is applied for every cell within a group. The delta information indicates a difference between a reference MCS index and an MCS index of each cell. The method as shown in FIG. 13 may set an average MCS index of cells within a group as a reference MCS index, when values of delta information of the cells within the group increases, and thereby provide an effect of averaging the values of delta information.
4-3. Information on CCs included in each group may be preconfigured in a RRC or be semi-statically notified to a terminal in a MAC CE.
4-4. In the above-described embodiments of 4-1 and 4-2, delta information for a reference MCS index, that is, an interval of delta values may be 1 but not be necessarily 1. For example, a base station may inform a terminal of a range of delta values with a specific interval such as {−4, −2, 0, 2, 4} in a higher layer beforehand and indicate a delta value, which is a difference from a reference MCS index, based on the range of delta values. As another example, a range of delta values may be {−5, −4, −1, 0, 1, 2, 3}. That is, a range of delta values may be modified, and delta values may not have an equal interval.

According to an embodiment, for a specific reference cell among cells that are scheduled through MC-DCI, a base station may configure and/or indicate an MCS field and/or MCS field information based on a full MCS table. Herein, the specific reference cell may be configured based on a cell index, an SCS, a CIF field, and an MC-DCI field. For example, a cell with a lowest cell index, a cell with a highest cell index, a cell configured to have a lowest SCS, a cell configured to have a highest SCS, or a cell indicated by a CIF field, or a cell transmitting MC-DCI may be set as a reference cell.

When configuring and/or indicating an MCS field and/or MCS field information for a specific reference cell based on a full MCS table, a base station may indicate, for the remaining cells, a relative offset value for a reference MCS index indicated in the MCS field of the reference cell. Accordingly, the remaining cells, a terminal may apply an MCS index (hereinafter, ‘delta MCS’) corresponding to a value obtained by adding the relative offset value to the reference MCS index. In this case, relative offset values for the remaining cells may be indicated in a range from 0 to a positive integer, in a range from 0 to a negative integer, or in a range from a negative integer to 0 to a positive integer. When a plurality of cell groups, to which a delta MCS scheme is applied, are set, a base station may configure and/or indicate an MCS field and/or an offset field for each cell group through MC-DCI based on the delta MCS scheme.

### Option-5: A Method of Applying Separate-Equal Among Cells and Applying Separate-Delta Among TBs.

Option-5 applies the separate-equal method of Option-1 among cells and applies the separate-delta method of Option-4 among TBs. That is, the present disclosure proposes a method for reducing the number of bits by setting one of 2-TB as a reference TB and applying delta to the other TB.
5-1. According to an embodiment, MCS information of TB1 may be operated with 5 bits, and MCS information of TB2 may be operated with 3 bits or 2 bits.
5-2. According to an embodiment, delta information for a reference MCS index among TBs, that is, an interval of delta values may be 1 but not be necessarily 1. For example, a higher layer may notify a range of delta values with a specific interval such as {−4, −2, 0, 2, 4} beforehand and indicate a delta value, which is a difference from a reference MCS index, based on the range of delta values. As another example, a range of delta values may be {−5, −4, −1, 0, 1, 2, 3}. That is, a range of delta values may be modified, and delta values may not have an equal interval.

According to an embodiment, for two TBs transmitted through a same PDSCH in a same cell among cells scheduled through MC-DCI, a base station may configure and/or indicate an MCS field and/or MCS field information based on the delta MCS method for the two TBs by applying the separate-delta method of Option-4. Herein, the separate-equal method of Option-1 may be applied to each cell so that a separate MCS field and/or offset field may be configured and/or indicated according to each cell. According to an embodiment, an MCS field and/or MCS information based on a full MCS table may be configured and/or indicated for a specific TB index (e.g., a lowest TB index) among two TBs that are transmitted through a same PDSCH in a same cell, and a relative offset value for an MCS index indicated trough an MCS field of a specific TB index may be indicated for the remaining TB index. The above-described Option-5 may be applied to a case in which a plurality of cells are scheduled through MC-DCI. When only one cell is scheduled through MC-DCI, a separate MCS field and/or MCS field information may be configured and/or indicated according to each TB. That is, when only one cell is scheduled through MC-DCI, the method of delta MCS is not applied, but a separate MCS field and/or MCS field information based on a full MCS table may be configured and/or indicated.

### Option-6: Other Various Additional Indication and Scheduling Configuration Methods

6-1. A base station may semi-statically notify and/or set per-cell MCS information to a terminal through a MAC CE. In this case, the terminal may decode a PDSCH for cells triggered by MC-DCI based on the per-cell MCS information that is already obtained through MAC CE.
6-2. As MCS information is in TB information, an amount of necessary information for MCS transmission becomes different according to the number of transmitted TBs. Specifically, depending on whether the number of TBs in each CC is 1 or 2, a total number of bits required for overall MCS transmission may be determined. Herein, not only the number of CCs scheduled in a PDCCH but also a total number of TBs may be signaled beforehand in a higher layer. That is, by limiting a total number of CCs and a total number of TBs, the number of indicated MCSs may be reduced. As the number of MCSs is reduced, the number of bits used for MCS indication may also be reduced.
6-3. In MC-DCI, an MCS field and/or at least one field is configured one by one according to each cell or each cell group. Herein, the remaining fields excluding a field configured for a reference CC may be mapped based on a CIF bit. The reference CC may be indicated through a higher layer or DCI. A CIF bit order may be determined based on a cell or a cell group. MCS information of the reference CC may be placed in the foremost part of a corresponding field.
6-4. A base station may indicate the number of scheduled CCs through a CIF. When information on a specific cell is not included in MC-DCI, the base station may mark any one bit of 3-bit CIF bits as 0 and thus indicate that a corresponding cell in a corresponding cell group or a scheduled CC is not actually scheduled. If a CIF bit is 1, MCS information of a reference CC itself is reused for a corresponding cell. Herein, not cells but cell groups may be mapped to 3 CIF bits.

According to an embodiment, since a CIF is configured with 3 bits, it is possible to indicate validity of three cell groups or three cells by using the CIF. Accordingly, whether to indicate MCS according to a share method or to indicate MCS according to a separate method may depend on the above-described options.

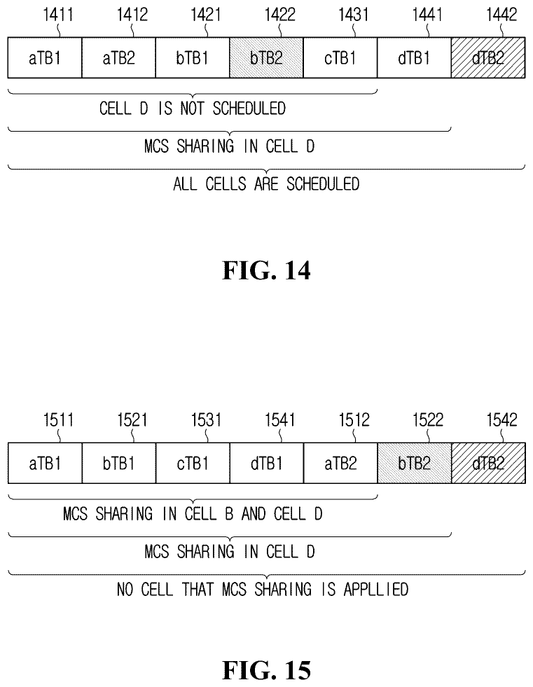

According to an embodiment, in principle, at least one field sharable by cells in a cell group is commonly used by the cells.
6-5. A plurality of cells to be scheduled through MC-DCI may be distinguished into a 1-TB cell with a maximum number of TBs being 1 and a 2-TB cell with a maximum number of TBs number being 2 through an MC-RNTI. Distinction of RNTIs according to a maximum number of TBs may also be applied to an MCS-MC-RNTI and an MC-CS-RNTI.
6-5-1. Based on a maximum number of TBs available in each cell, a plurality of MC-CS-RNTIs may be set in a higher layer. In a scheduled CC, the MC-CS-RNTIs may be grouped according to the maximum number of TBs.
6-5-2. A plurality of MC-CS-RNTIs may be set for an MC-DCI field, a scheduled cell, a cell group and the like, and an MC-RNTI, a C-RNTI and the like may be mixed for a single cell, multiple cells, a dynamic grant and/or a configured grant (CG).
6-6. A base station may set a maximum bit number of MCS, which can be transmitted by one piece of MC-DCI, and may determine the number of independent transmissible MCSs based on the maximum bit number.
6-6-1. For example, when a maximum bit number of an MCS, which can be transmitted by one piece of MC-DCI, is 10 bits, the number of MCS values, which can be transmitted within a range not exceeding 10 bits, may be determined. Thus, the base station may set MCS values in an MCS field within a range not exceeding a maximum bit number in MC-DCI and discard a portion exceeding the maximum bit number. According to an embodiment, a rule may be defined to restrict an MCS bit set in an MCS field from exceeding a maximum bit number of a preset MCS, irrespective of which option of the above-described options is used. According to an embodiment, a base station may control a specific field in DCI from occupying excessively many bits from the perspective of scheduling.
6-6-2. According to an embodiment, among fields in DCI except an MCS, in the case of a field that is to be signaled separately in a unit of cell or cell group, a maximum number of used bits of the field may be preset in a higher layer (e.g., a RRC layer or a MAC layer). As the maximum number of used bits is preset for the field, information on cells belonging to a port exceeding the maximum number of used bits may be discarded. That is, by controlling a specific field in DCI from exceeding a maximum number of used bits, the specific field may be prevented from using excessively many bits.
6-6-3. According to an embodiment, when a specific field is discarded, scheduling for a corresponding cell may be considered invalid.
6-7. In a multi-carrier aggregation situation, a CIF may indicate a start cell ID (CellID) of scheduled CCs. The number of cells successively scheduled after the start cell ID in MC-DCI may be preset in a higher layer. For example, when the number of scheduled CCs is 4 and an index of the start cell ID is 3, cells with cell ID indexes of 4, 5 and 6 may be scheduled together. Herein, through validity of additional RA or another pieces of bit information (e.g., VRB-PRB-mapping), it may be indicated that a specific cell is not actually scheduled.
6-8. A method of dividing TBs of a code block group (CBG) for URLLC has too high complexity in multi-cell scheduling and has a problem of HARQ processing between each cell, and thus this method may not be used.
6-9. In a situation where grouping is not performed for a plurality of cells, scheduling may be performed based on the number of CCs. Herein, if two MCS tables are configured for some cells in a plurality of CCs and one MCS table is configured for some other cells, various methods for processing an MCS-MC-RNTI may be applied.
6-9-1: Cells with one MCS being configured may be processed as not scheduled.
6-9-2: Cells with one MCS being configured may be processed to be scheduled by only one MCS table.
6-10. When there is one cell group or cell subgroup, four cells are scheduled simultaneously and a maximum number of transmission TBs of each cell is 2, since an MCS occupies 5 bits according to each TB, a total of 40 bits (=4×2×5) are occupied in MC-DCI. That is, because the MCS occupies too many bits in the MC-DCI, it is possible to apply a method of using one MCS value for a cell with two TBs being configured. That is, two TBs in a cell may be configured to share an MCS value. In this case, for a cell in which two TBs are transmitted, MCS information for 2-TB of the cell may be indicated only by 5 bits in an MCS field of MC-DCI.
6-10-1: Generally, a bit number for all the cells in an MCS field in MC-DCI may be calculated by a product of the sum of TB numbers of each cell in a combination having a maximum number of co-scheduled CCs and a designated bit number (e.g., 5 bits). However, if TBs in a cell share an MCS, a bit size for all the cells of the MCS field in MC-DCI may be calculated by a product of a maximum number of co-scheduled CCs and a designated bit number.
6-10-2: When MCS sharing is set in advance, only 5-bit MCS information may be configured for a corresponding cell in MC-DCI. Herein, for a 1-TB, 5-bit MCS information may be applied to the 1-TB, and for a 2-TB, 5-bit MCS information may be commonly applied two TBs.
6-11. A base station may determine an MCS field size in MC-DCI, that is, a total number of MCS bits as N(=5 bits x a sum of TBs of cells) and notify and/or configure the determined MCS field size to a terminal through RRC signaling.
6-11-1. An MCS field size may be predefined as 20 bits. In this case, while MCS sharing is not set, if at least one cell uses a 2-TB, an MCS of some cells may not be indicated.
6-11-2. When MCS sharing is set, as illustrated in FIG. 14 and FIG. 15, an MCS field may be configured based on a TB order or a cell order. FIG. 14 and FIG. 15 illustrate an example structure of an MCS field of MC-DCI in a wireless communication system according to an embodiment of the present disclosure. Specifically, FIG. 14 and FIG. 15 exemplify the structure of an MCS field of MC-DCI in a situation where the size of the MCS field is set maximally to 5×5 bits or 7×5 bits and a TB of cells, which are scheduled together by MC-DCI, is a cell A: 2-TB, a cell B: 2-TB, a cell C: 1-TB, and a cell D: 2-TB. In FIG. 14 and FIG. 15, 2-TB of the cell A are referred to as aTB1 and aTB2 respectively, 2-TB of the cell B are referred to as bTB1 and bTB2 respectively, 1-TB of the cell C is referred to as cTB1, and 2-TB of the cell D are expressed as dTB1 and dTB2 respectively. FIG. 14 is an example in which MCS information according to TB is added to an MCS field based on a cell order, and FIG. 15 is an example in which MCS information according to TB is added to an MCS field based on a TB order.

Referring to FIG. 14, when a maximum MCS field size is set to 7×5 bits, an MCS field may include an MCS 1411 of aTB1, an MCS 1412 of aTB2, an MCS 1421 of bTB1, an MCS 1422 of bTB2, an MCS 1431 of cTB1, an MCS 1441 of dTB1, and an MCS 1442 of dTB2. That is, when the maximum MCS field size is set to 7×5 bits, MCS scheduling is possible for all the cells to be co-scheduled.

According to an embodiment, when a maximum MCS field size is set to 6×5 bits, an MCS field may include the MCS 1411 of aTB1, the MCS 1412 of aTB2, the MCS 1421 of bTB1, the MCS 1422 of bTB2, the MCS 1431 of cTB1, and the MCS 1441 of dTB1. Herein, although the MCS 1442 of dTB2, which is the second TB of the cell D, is not included in the MCS field, if MCS sharing is configured, the MCS 1441 of dTB1 may be used as the MCS 1442 of dTB2.

According to an embodiment, when a maximum MCS field size is set to 5×5 bits, an MCS field may include the MCS 1411 of aTB1, the MCS 1412 of aTB2, the MCS 1421 of bTB1, the MCS 1422 of bTB2, and the MCS 1431 of cTB1. Herein, the MCS field does not the MCSs 1441 and 1442 for both the two TBs of the cell D. That is, as the MCS field size is limited, scheduling for the cell D is not performed.

Referring to FIG. 15, when a maximum MCS field size is set to 7×5 bits, an MCS field may include an MCS 1511 of aTB1, an MCS 1521 of bTB1, an MCS 1531 of cTB1, an MCS 1541 of dTB1, an MCS 1512 of aTB2, an MCS 1522 of bTB2, and an MCS 1542 of dTB2. That is, when the maximum MCS field size is set to 7×5 bits, MCS scheduling is possible for all the cells to be co-scheduled.

According to an embodiment, when a maximum MCS field size is set to 6×5 bits, an MCS field may include the MCS 1511 of aTB1, the MCS 1521 of bTB1, the MCS 1531 of cTB1, the MCS 1541 of dTB1, the MCS 1512 of aTB2, and the MCS 1522 of bTB2. Herein, although the MCS 1542 of dTB2, which is the second TB of the cell D, is not included in the MCS field, since the MCS 1541 of dTB1, which is the first TB of the cell D, is included, if MCS sharing is configured, the MCS 1541 of dTB1 may also be used as the MCS 1542 of dTB2.

According to an embodiment, when a maximum MCS field size is set to 5×5 bits, an MCS field may include the MCS 1511 of aTB1, the MCS 1521 of bTB1, the MCS 1531 of cTB1, the MCS 1541 of dTB1, and the MCS 1512 of aTB2. Herein, although the MCS field does not include the MCS 1522 of bTB2, which is the second TB of the cell B, and the MCS 1542 of dTB2 that is the second TB of the cell D, since the MCS 1521 of bTB1, which is the first TB of the cell B, and the MCS 1541 of dTB1, which is the first TB of the cell D, are included, if MCS sharing is configured, the MCS 1521 of bTB1 and the MCS 1541 of dTB1 may also be used as the MCS 1522 of bTB2 and the MCS 1542 of dTB2 respectively.

Among the situations described with reference to FIG. 15, there is no situation in which a cell is not scheduled through an MCS field within MC-DCI. Accordingly, depending on situation, the method of FIG. 15 may be more advantageous than the method of FIG. 14. That is, when MCS sharing is configured, because MCS values in an MCS field are shared by different TBs, the configuration of an MCS field as shown in FIG. 15 may be effective in a situation in which the number of TBs can be dynamically changed in an MIMO layer.

As described above, multi-carrier scheduling may be performed according to various embodiments. MC-DCI may be used for multi-carrier scheduling, and the MC-DCI includes at least one field including a coding rate and modulation order information for a plurality of CCs, that is, MCS information. Herein, the operations of a base station and a terminal performing multi-carrier scheduling according to the above-described embodiments will be described with reference to drawings.

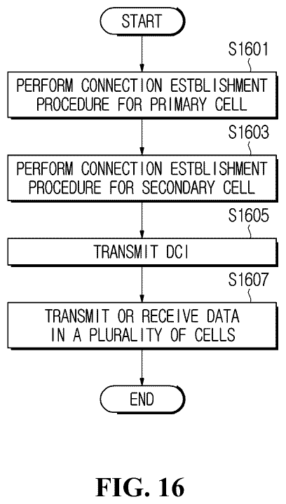

FIG. 16 illustrates an example of a procedure for obtaining frequency domain resource information in a wireless communication system according to an embodiment of the present disclosure. FIG. 16 exemplifies a method for operating a base station.

Referring to FIG. 16, at step S1601, the base station performs a connection establishment procedure for a primary cell. After the base station accesses a terminal, the base station performs a connection establishment procedure with the terminal. To this end, the base station may receive a setup request message for connection from the terminal and transmit a setup complete message. Although not illustrated in FIG. 16, prior to step S1601, the base station may perform an initial access procedure by receiving a random access preamble from the terminal and transmitting a random access response (RAR) message.

At step S1603, the base station performs a connection establishment procedure for at least one secondary cell. After the connection for the primary cell of the terminal is established, the base station performs an additional connection establishment procedure with the terminal. To this end, the base station may receive a reconfiguration message for connection from the terminal and transmit a reconfiguration complete message. Thus, one primary cell and at least one secondary cell between the base station and the terminal may be configured. In addition, although not illustrated in FIG. 16, the base station may transmit a MAC CE for activating the at least one secondary cell.

At step S1605, the base station transmits DCI. Herein, the DCI may include information for multi-carrier scheduling. That is, the base station allocates resources of a plurality of cells to the terminal, generates DCI indicating the allocated resources, and transmits the DCI to the terminal through one of the plurality of cells. For example, the DCI may include information indicating resources allocated in a plurality of cells including one primary cell and at least one secondary cell. Herein, per-cell and/or per-TB MCS information may be indicated according to the above-described various embodiments. Depending on situations, the resources may not be allocated in some of the plurality of cells. In this case, the DCI may include information indicating at least one cell in which no resource is allocated, that is, at least one cell that is not actually scheduled.

At step S1607, the base station transmits or receives data in a plurality of cells. The base station may transmit or receive data through resources of a plurality of cells indicated by DCI. If a downlink resource is allocated by the DCI, the base station transmits data. To this end, the base station may perform channel encoding, scrambling, rate mapping, constellation mapping, resource mapping, layer mapping, waveform modulation and the like. If an uplink resource is allocated by the DCI, the base station receives data. To this end, the base station may perform waveform demodulation, constellation demapping, channel decoding and the like.

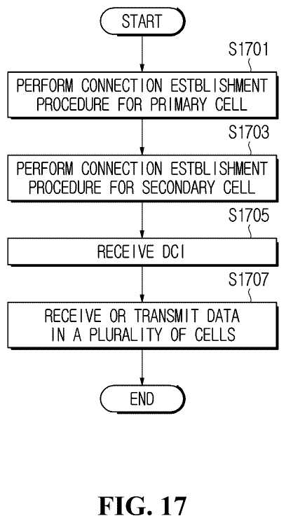

FIG. 17 illustrates an example of a procedure for transmitting frequency domain resource information in a wireless communication system according to an embodiment of the present disclosure. FIG. 17 exemplifies a method for operating a terminal.

Referring to FIG. 17, at step S1701, the terminal performs a connection establishment procedure for a primary cell. After the terminal accesses a base station, the terminal performs a connection establishment procedure with the base station. To this end, the terminal may transmit a setup request message for connection to the base station and receive a setup complete message. Although not illustrated in FIG. 17, prior to step S1701, the terminal may perform an initial access procedure by transmitting a random access preamble to the base station and receiving a random access response (RAR) message.

At step S1703, the terminal performs a connection establishment procedure for at least one secondary cell. After the connection for the primary cell of the terminal is established, the terminal performs an additional connection establishment procedure with the base station. To this end, the terminal may transmit a reconfiguration message for connection to the base station and receive a reconfiguration complete message. Thus, one primary cell and at least one secondary cell between the base station and the terminal may be configured. In addition, although not illustrated in FIG. 17, the terminal may receive a MAC CE for activating the at least one secondary cell.

At step S1705, the terminal receives DCI. Herein, the DCI may include information for multi-carrier scheduling. That is, the terminal may identify a result of the multi-carrier scheduling through the DCI. For example, the DCI may include information indicating resources allocated in a plurality of cells including one primary cell and at least one secondary cell. Herein, per-cell and/or per-TB MCS information may be indicated according to the above-described various embodiments. Depending on situations, the resources may not be allocated in some of the plurality of cells. In this case, the DCI may include information indicating at least one cell in which no resource is allocated, that is, at least one cell that is not actually scheduled.

At step S1707, the terminal receives or transmits data in a plurality of cells. The terminal may receive or transmit data through resources of a plurality of cells indicated by the DCI. If a downlink resource is allocated by the DCI, the terminal receives data. To this end, the terminal may perform waveform demodulation, constellation demapping, channel decoding and the like. If an uplink resource is allocated by the DCI, the terminal transmits data. To this end, the terminal may perform channel encoding, scrambling, rate mapping, constellation mapping, resource mapping, layer mapping, waveform modulation and the like.

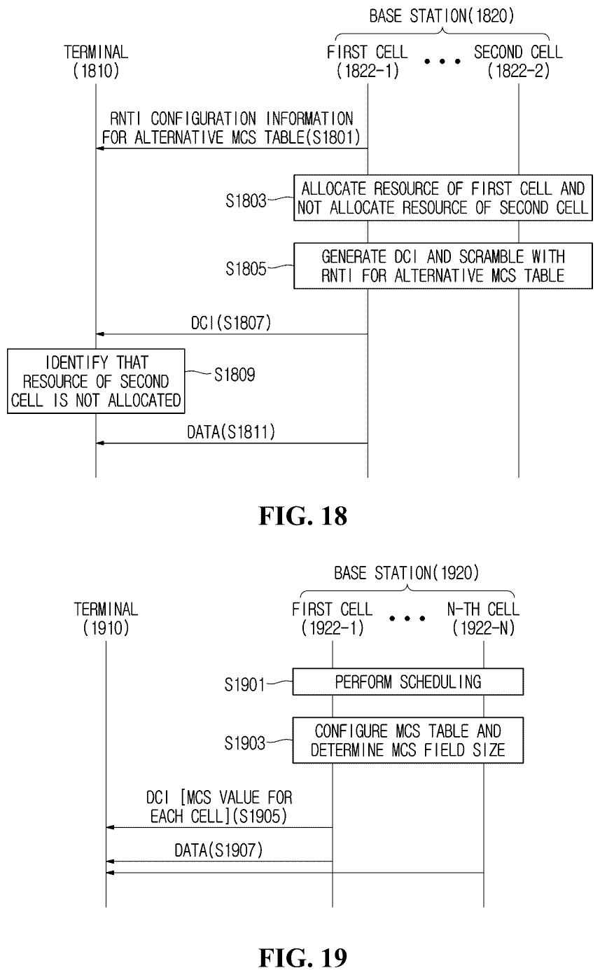

FIG. 18 illustrates an example of a procedure for indicating a resource allocation situation by using a radio network temporary identifier (RNTI) in a wireless communication system according to an embodiment of the present disclosure. FIG. 18 exemplifies signal exchange between a terminal 1810 and a base station 1820. In FIG. 18, the base station 1820 is described to provide two cells 1822-1 and 1822-2, but the procedure described below may also be applied to a situation in which three or more cells are provided.

Referring to FIG. 18, at step S1801, the base station 1820 transmits RNTI-related configuration information for an alternative MCS table to the terminal 1810. Herein, the alternative MCS table is an additional MCS table different from a default MCS table and may be allowed to be used for the terminal 1801 according to a configuration of the base station 1820. The configuration information may include information (e.g., a RNTI value) related to a RNTI (e.g., MCS-C-RNTI) for indicating the use of the alternative MCS table and include an IE (e.g., PhysicalCellGroupConfig) of a RRC layer. In this embodiment, a RNTI for the alternative MCS table is configured for the first cell 1822-1 and is not configured for the second cell 1822-2.

At step S1803, the base station 1820 allocates a resource of the first cell 1822-1 to the terminal 1810 and does not allocate a resource of the second cell 1822-2. Herein, the first cell 1822-1 and the second cell 1822-2 are CCs that are configured to the terminal 1810 by carrier aggregation, and one of the first cell 1822-1 and the second cell 1822-2 is a primary cell, and the other one is a secondary cell. Herein, the first cell 1822-1 and the second cell 1822-2 are configured to be scheduled by using one pieces of DCI (e.g., MC-DCI) through multi-carrier scheduling. In addition, for the first cell 1822-1, a RNTI is configured for the alternative MCS table, and for the second cell 1822-2, no RNTI is configured for the alternative MCS table.

At step S1805, the base station 1820 generates DCI for the first cell 1822-1 and the second cell 1822-2. In addition, the base station 1820 scrambles the generated DCI by using the RNTI for the alternative MCS table. Scrambling by the RNTI for the alternative MCS table indicates application of the alternative MCS table. That is, the DCI includes information indicating that the alternative MCS table is to be applied. Herein, the alternative MCS table may be predefined or be configured through signaling for RNTI configuration or separate signaling.

At step S1807, the base station 1820 transmits the DCI to the terminal 1810. That is, the base station 1820 transmits information on a resource that is allocated at step S1801. Herein, the DCI is in a state of being scrambled by a RNTI for the alternative MCS table configured for the first cell 1822-1. Accordingly, as for a cell for which no RNTI is configured for the alternative MCS table, the transmitted DCI may be interpreted as allocating no resource, that is, as not actually being scheduled. In other words, the DCI transmitted at this step includes information indicating that no resource of the second cell 1822-2 is allocated, that is, no actual scheduling is performed in the second cell 1822-2.

At step S1809, the terminal 1810 identifies that the resource of the second cell 1822-2 is not allocated. The terminal 1810 receives the DCI and attempts to decode the DCI by using at least one RNTI. Accordingly, the terminal 1810 may confirm that decoding is successful through a RNTI for the alternative MCS table and may determine that the alternative MCS table is applied. Accordingly, for a cell for which no RNTI for the alternative MCS table is configured, that is, for the second cell 1822-2, the terminal 1810 may confirm that it is not actually scheduled. In addition, the terminal 1810 identifies a resource allocated in the first cell 1822-1 through the DCI.

At step S1807, the base station 1820 transmits data to the terminal 1810 through the resource of the first cell 1822-1. In other words, the base station 1820 transmits a signal including the data to the terminal 1810 through a PDSCH of the first cell 1822-1. Herein, the PDSCH is mapped to a resource indicated by the DCI that is transmitted at step S1805.

FIG. 19 illustrates an example of a procedure for performing multi-carrier scheduling according to a separate-equal scheme in a wireless communication system according to an embodiment of the present disclosure. FIG. 19 exemplifies signal exchange between a terminal 1910 and a base station 1920.

Referring to FIG. 19, at step S1901, the base station 1920 performs scheduling. The base station 1920 provides a first cell 1922-1 to an N-th cell 1922-N to the terminal 1910 by using carrier aggregation and performs scheduling to perform communication using resources of the first cell 1922-1 to the N-th cell 1922-N. Accordingly, a resource of each of the first cell 1922-1 to the N-th cell 1922-N may be allocated to the terminal 1910.

At step S1903, the base station 1920 configures an MCS table and determines an MCS field size. The MCS table is configured based on a full MCS table. Herein, the full MCS table may be understood as an MCS table that is used for single carrier scheduling. For example, the base station 1920 may configure a new MCS table including some of MCS indexes included in a full MCS table. In addition, the base station 1920 determines an MCS field size. For example, the base station 1920 may determine the size of an MCS field based on at least one of a configured MCS table, the number of scheduled cells, and a TB number of each cell.

According to another embodiment, an MCS table may be configured prior to the scheduling of step S1901.

At step S1905, the base station 1920 transmits DCI to a resource of the first cell 1922-1. Herein, the DCI includes MCS values for each cell. That is, the base station 1920 generates MCS values for each of the plurality of cells 1922-1 to 1922-N. An MCS value for each cell indicates one of indexes in the MCS table configured at step S1903. According to an embodiment, if at least one cell of the cells 1922-1 to 1922-N included in a group is not actually scheduled, the DCI may further include information indicating at least one cell that is not actually scheduled, that is, invalid. For example, a value indicating an index not included in an MCS table may be used as information indicating an invalid cell.

At step S1907, the base station 1920 transmits data by using a resource of the first cell 1922-1 to the N-th cell 1922-N. Based on the MCS values included in the DCI, the terminal 1910 may identify an encoding rate and a modulation order that are applied to data transmitted in each of the first cell 1922-1 to the N-th cell 1922-N. Accordingly, the terminal 1910 may perform constellation demapping and channel decoding for a signal that is received in each of the first cell 1922-1 to the N-th cell 1922-N.

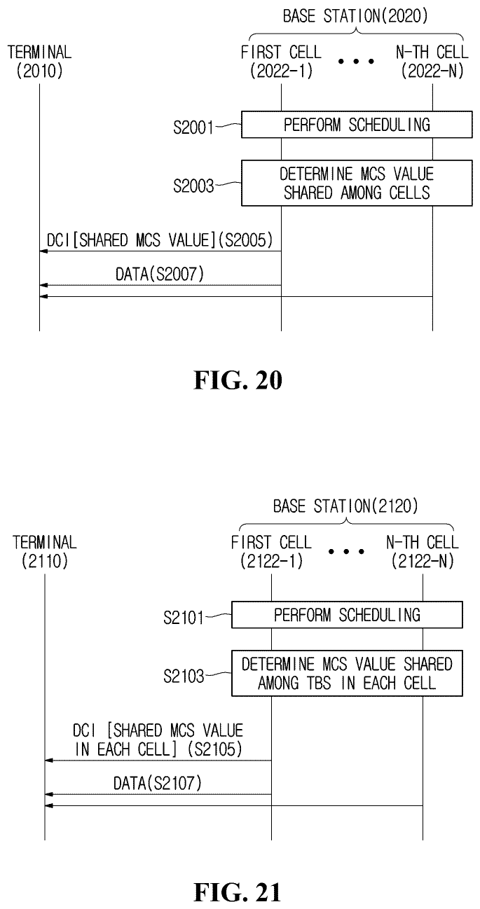

FIG. 20 illustrates an example of a procedure for performing multi-carrier scheduling according to a shared-common scheme in a wireless communication system according to an embodiment of the present disclosure. FIG. 20 exemplifies signal exchange between a terminal 2010 and a base station 2020.

Referring to FIG. 20, at step S2001, the base station 2020 performs scheduling. The base station 2020 provides a first cell 2022-1 to an N-th cell 2022-N to the terminal 2010 by using carrier aggregation and performs scheduling to perform communication using resources of the first cell 2022-1 to the N-th cell 2022-N. Accordingly, a resource of each of the first cell 2022-1 to the N-th cell 2022-N may be allocated to the terminal 2010.

At step S2003, the base station 2020 determines an MCS value shared by the cells 2022-1 to 2022-N. In other words, the base station 2020 determines a common MCS value for all the cells 2022-1 to 2022-N. To determine the common MCS value, the base station 2020 may comprehensively consider channel information selected from each of the cells 2022-1 to 2022-N. Herein, the shared MCS value may be shared by co-scheduled cells, and the co-scheduled cells may be configured before or after step S2001 is implemented. If necessary, although not illustrated in FIG. 20, the base station 2020 may transmit information indicating cells sharing the common MCS value to the terminal 2010.

At step S2005, the base station 2020 transmits DCI through a resource of the first cell 2022-1. In other words, the base station 2020 transmits the DCI through a PDCCH of the first cell 2022-1. Herein, the DCI includes the shared MCS value generated at step S2003. That is, the DCI may include a resource allocation result for each of the cells 2022-1 to 2022-N and MCS information that is commonly applied. Alternatively, if a plurality of groups are formed, the DCI may further include identification information for the groups. If at least one cell of the cells 2022-1 to 2022-N included in a group is not actually scheduled, the DCI may further include information indicating at least one cell that is not actually scheduled, that is, invalid.

At step S2007, the base station 2020 transmits data by using a resource of the first cell 2022-1 to the N-th cell 2022-N. Based on the MCS values included in the DCI, the terminal 2010 may identify an encoding rate and a modulation order that are applied to data transmitted in each of the first cell 2022-1 to the N-th cell 2022-N. Accordingly, the terminal 2010 may perform constellation demapping and channel decoding for a signal that is received in each of the first cell 2022-1 to the N-th cell 2022-N.

FIG. 21 illustrates an example of a procedure for performing multi-carrier scheduling according to a shared-common scheme between cells and a separate-delta scheme between TBs in a wireless communication system according to an embodiment of the present disclosure. FIG. 21 exemplifies signal exchange between a terminal 2110 and a base station 2120.

Referring to FIG. 21, at step S2101, the base station 2121 performs scheduling. The base station 2121 provides a first cell 2122-1 to an N-th cell 2122-N to the terminal 2110 by using carrier aggregation and performs scheduling to perform communication using resources of the first cell 2122-1 to the N-th cell 2122-N. Accordingly, a resource of each of the first cell 2122-1 to the N-th cell 2122-N may be allocated to the terminal 2110.

At step S2103, the base station 2121 determines an MCS value shared among TBs in each cell. In other words, the base station 2121 determines respective MCS values for the cells 2122-1 to 2122-N, and each of the MCS values is commonly applied to TBs in each cell. That is, for each of the cells 2122-1 to 2122-N, the base station 2121 determines one per-cell MCS value that is shared among TBs. To this end, the base station 2121 may configure an MCS table including some of MCS indexes included in a full MCS table for the separate-equal scheme among the cells 2122-1 to 2122-N and determine an MCS field size. Herein, because an MCS value is shared among TBs, the number of TBs may not be considered in determining the MCS field size.

At step S2105, the base station 2121 transmits DCI through a resource of the first cell 2122-1. In other words, the base station 2121 transmits the DCI through a PDCCH of the first cell 2122-1. Herein, the DCI includes the MCS value that is shared among TBs in each cell and is generated at step S2103. That is, the DCI may include a resource allocation result for each of the cells 2122-1 to 2122-N and MCS information commonly applied to TBs in each cell. Alternatively, when a plurality of groups are formed, the DCI may further include identification information for the groups. If at least one cell of the cells 2122-1 to 2122-N included in a group is not actually scheduled, the DCI may further include information indicating at least one cell that is not actually scheduled, that is, invalid.

At step S2107, the base station 2121 transmits data by using a resource of the first cell 2122-1 to the N-th cell 2122-N. Based on the MCS values included in the DCI, the terminal 2110 may identify an encoding rate and a modulation order that are applied to data transmitted in each of the first cell 2122-1 to the N-th cell 2122-N. Accordingly, the terminal 2110 may perform constellation demapping and channel decoding for a signal that is received in each of the first cell 2122-1 to the N-th cell 2122-N.

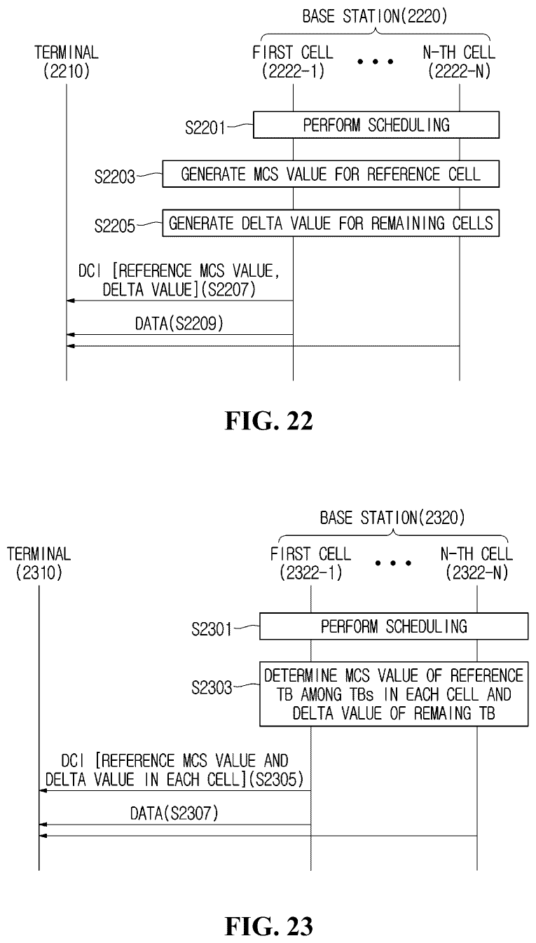

FIG. 22 illustrates an example of a procedure for performing multi-carrier scheduling according to a separate-delta scheme in a wireless communication system according to an embodiment of the present disclosure. FIG. 22 exemplifies signal exchange between a terminal 2210 and a base station 2220.

Referring to FIG. 22, at step S2201, the base station 2220 performs scheduling. The base station 2221 provides a first cell 2220-1 to an N-th cell 2220-N to the terminal 2210 by using carrier aggregation and performs scheduling to perform communication using resources of the first cell 2220-1 to the N-th cell 2220-N. Accordingly, a resource of each of the first cell 2220-1 to the N-th cell 2220-N may be allocated to the terminal 2210.

At step S2203, the base station 2220 generates an MCS value for a reference cell. To this end, the base station 2220 may determine a group of co-scheduled cells using one PDCCH and select the reference cell from the cells belonging to the group. In this embodiment, the first cell 2220-1 to the N-th cell 2220-N are bound into one group. For example, the reference cell may be selected based on at least one of a cell index, a bandwidth, channel quality, SCS, and another DCI field. In addition, the base station 2220 may generate an MCS value for the reference cell.

At step S2205, the base station 2220 generates a delta value for at least one remaining cell. That is, the base station 2220 generates information capable of indicating an MCS index that is applied to another cell by being combined with the MCS value for the reference cell. The delta value is generated for each of the remaining cells other than the reference cell and may indicate a difference of index from the MCS value of the reference cell. Herein, candidates of the index difference, which can be indicated by the delta value, may be preconfigured, and the candidates of the index difference may be configured to have an equal interval or to have a non-equal interval.

At step S2207, the base station 2220 transmits DCI through a resource of the first cell 2220-1. In other words, the base station 2220 transmits the DCI through a PDCCH of the first cell 2220-1. Herein, the DCI includes the MCS value generated at step S2203 and at least one delta value generated at step S2220. Alternatively, when a plurality of groups are formed, the DCI may further include identification information for the groups. If at least one cell of the cells 2220-1 to 2220-N included in a group is not actually scheduled, the DCI may further include information indicating at least one cell that is not actually scheduled, that is, invalid. In addition, the DCI may further include information indicating the reference cell.

At step S2209, the base station 2220 transmits data by using a resource of the first cell 2222-1 to the N-th cell 2222-N. Based on an MCS value and at least one delta value included in the DCI, the terminal 2210 may identify an encoding rate and a modulation order that are applied to data transmitted in each of the first cell 2222-1 and the N-th cell 2222-N. Thus, the terminal 2210 may perform constellation demapping and channel decoding for a signal that is received in each of the first cell 2222-1 to the N-th cell 2222-N.

According to the embodiment described with reference to FIG. 22, an MCS value for a reference cell and at least one delta value for at least one different cell are transmitted. Herein, the MCS value for the reference cell is used as a criterion for determining an MCS value of at least one different cell based on the least one delta value. According to another embodiment, the MCS value used for determining the MCS value of at least one different cell may be determined without the reference cell. For example, a reference MCS value may be a predefined value or may be determined based on MCS values of the cells 2222-1 to 2222-N. In this case, the MCS value for the reference cell may not be transmitted, and respective delta values for the cells 2222-1 to 2222-N may be transmitted.

FIG. 23 illustrates an example of a procedure for performing multi-carrier scheduling according to a separate-equal scheme between cells and a separate-delta scheme between TBs in a wireless communication system according to an embodiment of the present disclosure. FIG. 23 exemplifies signal exchange between a terminal 2310 and a base station 2320.

Referring to FIG. 23, at step S2301, the base station 2320 performs scheduling. The base station 2320 provides a first cell 2322-1 to an N-th cell 2322-N to the terminal 2310 by using carrier aggregation and performs scheduling to perform communication using resources of the first cell 2322-1 to the N-th cell 2322-N. Accordingly, a resource of each of the first cell 2322-1 to the N-th cell 2322-N may be allocated to the terminal 2310.

At step S2303, the base station 2320 determines an MCS value shared among TBs in each cell. In other words, the base station 2320 determines MCS information for each of the cells 2322-1 to 2322-N, and the MCS information includes a reference MCS value and at least one delta value for TBs of a corresponding cell. That is, for each of the cells 2322-1 to 2322-N, the base station 2320 determines an MCS value for one of the TBs and determines at least delta value for at least one remaining TB. To this end, the base station 2320 may configure an MCS table including some of MCS indexes included in a full MCS table for the separate-equal scheme among the cells 2322-1 to 2322-N and determine an MCS field size.

At step S2305, the base station 2320 transmits DCI through a resource of the first cell 2322-1. In other words, the base station 2320 transmits the DCI through a PDCCH of the first cell 2322-1. Herein, the DCI is the per-cell MCS information generated at step S2303 and includes a reference MCS value and at least one delta value for TBs. That is, the DCI may include a resource allocation result for each of the cells 2322-1 to 2322-N and MCS information including a reference MCS value and at least one delta value applied to TBs of each cell. Alternatively, when a plurality of groups are formed, the DCI may further include identification information for the groups. If at least one cell of the cells 2322-1 to 2322-N included in a group is not actually scheduled, the DCI may further include information indicating at least one cell that is not actually scheduled, that is, invalid.

At step S2307, the base station 2320 transmits data by using a resource of the first cell 2322-1 to the N-th cell 2322-N. Based on a per-cell reference MCS value and at least one delta value included in the DCI, the terminal 2310 may identify an encoding rate and a modulation order that are applied to data transmitted in each of the first cell 2322-1 and the N-th cell 2322-N. Thus, the terminal 2310 may perform constellation demapping and channel decoding for a signal that is received in each of the first cell 2322-1 to the N-th cell 2322-N.

Mult-carrier scheduling may be performed according to the above-described various procedures. The procedures described with reference to FIG. 19 to FIG. 23 are examples of procedures according to the shared-common scheme, the separate-delta scheme, the separate-equal scheme, or a combination of two or more of them. However, the above-described procedures may be jointly applied. Furthermore, those various embodiments described in the above various options (e.g., Option-1 to Option-5) may be combined in the above-described procedures. Accordingly, multi-carrier scheduling according to various embodiments of the present disclosure may be modified in more various ways.

With the evolution and advance to 5G NR, a frequency band capable of simultaneous transmission using carrier aggregation has increased up to 6 GHz or more or various mmWave bands of 20 GHZ, 30 GHz, 60 GHz and 100 GHz, and thus the number of cells, which are operated simultaneously, has increased significantly. Since the previous 4G system, irrespective of whether a self-scheduling or a cross-carrier scheduling scheme is used, one PDCCH is decoded in principle, that is, DCI is transmitted at least once for one PDSCH transmission in a single cell. When a smaller number of PDSCHs are transmitted simultaneously, decoding the PDCCH several times may not be very burdensome. However, if the number of PDCCHs to be decoded is equal to or greater than a certain level, not only the performance of a terminal may be affected, but also frequency and time resources may be greatly consumed. Accordingly, the resource for traffic transmission may be reduced.

Therefore, it is desirable to use one PDCCH for scheduling PDSCHs of a plurality of cells. However, because a maximum amount of available information is limited in the 5G NR system, it is difficult to allocate a lot of bits for specific information. In particular, when the number of TBs is 2 or there are many CCs, it is known that MCS information has least connection or common features between the TBs or the CCs in comparison with a DCI field of another PDCCH. Accordingly, a bit number representing MCS information needs to be reduced or optimized according to situations so that the MCS information may be delivered for many CCs through a relatively small amount of information. Thus, MCS information may be effectively delivered through various options according to the above-described various embodiments of the present disclosure. In addition, the above-described embodiments may help improve the usability of scheduling through MC-DCI.

Examples of the above-described proposed methods may be included as one of the implementation methods of the present disclosure and thus may be regarded as kinds of proposed methods. In addition, the above-described proposed methods may be independently implemented or some of the proposed methods may be combined (or merged). The rule may be defined such that the base station informs the UE of information on whether to apply the proposed methods (or information on the rules of the proposed methods) through a predefined signal (e.g., a physical layer signal or a higher layer signal).

Those skilled in the art will appreciate that the present disclosure may be carried out in other specific ways than those set forth herein without departing from the spirit and essential characteristics of the present disclosure. The above exemplary embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein. Moreover, it will be apparent that some claims referring to specific claims may be combined with another claims referring to the other claims other than the specific claims to constitute the embodiment or add new claims by means of amendment after the application is filed.

The embodiments of the present disclosure are applicable to various radio access systems. Examples of the various radio access systems include a 3rd generation partnership project (3GPP) or 3GPP2 system.

The embodiments of the present disclosure are applicable not only to the various radio access systems but also to all technical fields, to which the various radio access systems are applied. Further, the proposed methods are applicable to mmWave and THzWave communication systems using ultrahigh frequency bands.

Additionally, the embodiments of the present disclosure are applicable to various applications such as autonomous vehicles, drones and the like.

1. A method comprising:
performing a random access procedure with a base station;
performing a connection establishment procedure for a primary cell with the base station;
performing a connection establishment procedure for at least one secondary cell with the base station;
receiving downlink control information (DCI) from the base station; and
receiving data by using resources indicated by the DCI,
wherein the DCI includes information indicating modulation and coding scheme (MCS) information applied to a plurality of cells including the primary cell and the at least one secondary cell.

2. The method of claim 1, wherein the DCI includes information indicating, among the plurality of the cells, at least one cell that is not actually scheduled.

3. The method of claim 2, wherein the information indicating the at least one cell that is not actually scheduled includes scrambling the DCI by using a radio network temporary identifier (RNTI) for an alternative MCS table in a situation including a cell to which the RNTI for the alternative MCS table is not allocated.

4. The method of claim 1, wherein the DCI includes an MCS value that is commonly applied to the plurality of the cells.

5. The method of claim 4, wherein the commonly applied MCS value is determined based on an MCS table including a portion of indexes included in a full MCS table that is used for single-carrier scheduling.

6. The method of claim 1, further comprising transmitting information related to an MCS table, which is used to determine the commonly applied MCS value, through DCI, media access control (MAC), control element (CE) or radio resource control (RRC) signaling.

7. The method of claim 1, wherein the DCI includes an MCS value for a reference cell among the plurality of the cells and at least one delta value for at least one remaining cell.

8. The method of claim 1, wherein the DCI includes delta values for the plurality of the cells respectively, and
wherein each of the delta values indicates a difference between a reference MCS value and an MCS value for each of the plurality of the cells.

9. The method of claim 8, wherein the reference MCS value includes an average of MCS values of the plurality of the cells.

10. The method of claim 1, wherein the MCS information includes MCS values for the plurality of the cells respectively, and
wherein each of the MCS values is commonly applied to transport blocks (TBs) included in a corresponding cell.

11. The method of claim 1, wherein the MCS information includes a reference MCS value and at least one delta value for each of the plurality of the cells,
wherein the reference MCS value is applied to one of TBs included in a corresponding cell, and
wherein the at least one delta value indicates an index difference between an MCS value applied to at least one remaining TB of the TBs included in the corresponding cell and the reference MCS value.

12. A method comprising:
performing a random access procedure with a user equipment (UE);
performing a connection establishment procedure for a primary cell of the UE;
performing a connection establishment procedure for at least one secondary cell of the UE;
transmitting downlink control information (DCI) to the UE; and
transmitting data by using resources indicated by the DCI,
wherein the DCI includes information indicating modulation and coding scheme (MCS) information applied to a plurality of cells including the primary cell and the at least one secondary cell.

13. The method of claim 12, wherein the DCI includes information indicating, of the primary cell and the at least one secondary cell, at least one cell that is not actually scheduled.

14. The method of claim 13, wherein the information indicating the at least one cell that is not actually scheduled includes scrambling the DCI by using a radio network temporary identifier (RNTI) for an alternative MCS table in a situation including a cell to which the RNTI for the alternative MCS table is not allocated.

15. The method of claim 12, wherein the DCI includes an MCS value that is commonly applied to the plurality of the cells.

16. The method of claim 12, wherein the DCI includes an MCS value for a reference cell among the plurality of the cells and at least one delta value for at least one remaining cell.

17. A user equipment (UE) in a wireless communication system, the UE comprising:
a transceiver; and
a processor coupled with the transceiver,
wherein the processor is configured to:
perform a random access procedure with a base station,
perform a connection establishment procedure for a primary cell with the base station,
perform a connection establishment procedure for at least one secondary cell with the base station,
receive downlink control information (DCI) from the base station, and
receive data by using resources indicated by the DCI, and
wherein the DCI includes information indicating modulation and coding scheme (MCS) information applied to a plurality of cells including the primary cell and the at least one secondary cell.

18-20. (canceled)

21. The UE of claim 17, wherein the DCI includes information indicating, among the plurality of the cells, at least one cell that is not actually scheduled.

22. The UE of claim 17, wherein the DCI includes an MCS value that is commonly applied to the plurality of the cells.

23. The UE of claim 17, wherein the processor is further configured to transmit information related to an MCS table, which is used to determine the commonly applied MCS value, through DCI, media access control (MAC), control element (CE) or radio resource control (RRC) signaling.
